(19) United States
(12) Patent Application Publication
(10) Pub. No.: US 2026/0369033 A1
(43) Pub. Date: Nov. 19, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Tokyo (JP)

(72) Inventors: Yuji TAHARA, Tokyo (JP); Yaeko YONEZAWA, Tokyo (JP)

(73) Assignee: NEC Corporation, Tokyo (JP)

(21) Appl. No.: 19/148,360

(22) PCT Filed: Jan. 20, 2023
(86) PCT No.: PCT/JP2023/001649

§ 371 Date: Jul. 16, 2025

(51) Int. Cl. G06V 10/764; G06Q 10/087; G06V 10/22; G06V 10/26; G06V 10/75; G06V 20/62

(52) U.S. Cl. CPC G06V 10/764; G06Q 10/08724; G06V 10/23; G06V 10/26; G06V 10/759; G06V 20/63

(57) ABSTRACT

An information processing device (100) comprises: a region identification unit (102) that, by analyzing an image including a product shelf, identifies a product region for each product and identifies a shelf tag region, which is a region including a shelf tag; and a correspondence relationship identification unit (104) that identifies a product region corresponding to a shelf tag, on the basis of the positional relationship between the position of the product region and the position of the shelf tag region. The correspondence relationship identification unit (104) identifies two adjacent shelf tags, and identifies a product region corresponding to each shelf tag by setting a boundary indicating a classification division of products in the product region, either between the product regions corresponding to the regions above each of the two shelf tags or between the two shelf tags.

### TECHNICAL FIELD

The present invention relates to an information processing system, an information processing device, an information processing method, and a recording medium.

### BACKGROUND ART

An example of an article recognition device that recognizes an article is disclosed in PTL 1. The article recognition device of PTL 1 includes an image interface that acquires a captured image obtained by capturing an image of an article, and a processor that extracts a plurality of article regions of the articles from the captured image, extracts feature information indicating a feature of the article region from each of the article regions, and identifies a boundary of a same type of region where articles of a same type exist based on the feature information of two adjacent article regions.

### CITATION LIST

### Patent Literature

PTL 1: JP 2020-68006 A

### SUMMARY OF INVENTION

### Technical Problem

In the technique disclosed in PTL 1 described above, a position of a shelf label is identified from the image, a same type region in which the same type of products exist is identified, and the shelf label indicating the product in the same type region is identified from a position of the same type region and the position of the shelf label. As described above, in the technology disclosed in PTL 1, since the same type region where the same type of products exist is identified, for example, there is a problem that different products of the same series having similar packages may be recognized as the same type of products. That is, there is a problem in accuracy of automatic detection of shelf allocation by image recognition.

In view of the above-described problems, an object of the present invention is to provide an information processing system, an information processing device, an information processing method, and a recording medium that solve a problem that accuracy of automatic detection of allocation by image recognition

### Solution to Problem

According to one aspect of the present invention, there is provided an information processing device including,
a region identification means for identifying a product region for each product and identifying a shelf label region which is a region including a shelf label by analyzing an image including a product shelf, and
a correspondence identification means for identifying the product region associated to the shelf label based on a positional relationship between a position of the product region and a position of the shelf label region, in which
the correspondence identification means
identifies two of the shelf labels adjacent to each other, and identifies the product region associated to each of the shelf labels by setting a boundary indicating a separation of types of the products in the product region for each of the product regions associated to an upper region of each of the two shelf labels or between the two shelf labels.

According to another aspect of the present invention, there is provided an information processing system including,
a camera for capturing an image of a product shelf; and
an information processing device, in which
the information processing device includes,
a region identification means for identifying a product region for each product and identifying a shelf label region which is a region including a shelf label by analyzing an image including a product shelf, and
a correspondence identification means for identifying the product region associated to the shelf label based on a positional relationship between a position of the product region and a position of the shelf label region, and
the correspondence identification means of the information processing device
identifies two of the shelf labels adjacent to each other, and identifies the product region associated to each of the shelf labels by setting a boundary indicating a separation of types of the products in the product region for each of the product regions associated to an upper region of each of the two shelf labels or between the two shelf labels.

According to still another aspect of the present invention, there is provided an information processing method for causing one or more computers to execute processing of,
identifying a product region for each product and identifying a shelf label region which is a region including a shelf label by analyzing an image including a product shelf,
identifying the product region associated to the shelf label based on a positional relationship between a position of the product region and a position of the shelf label region, and
when identifying a correspondence, identifying two of the shelf labels adjacent to each other, and identifying the product region associated to each of the shelf labels by setting a boundary indicating a separation of types of the products in the product region for each of the product regions associated to an upper region of each of the two shelf labels or between the two shelf labels.

According to further aspect of the present invention, there is provided a computer-readable recording medium recording a program for causing a computer to execute
region identification processing for identifying a product region for each product and identifying a shelf label region which is a region including a shelf label by analyzing an image including a product shelf, and
correspondence identification processing for identifying the product region associated to the shelf label based on a positional relationship between a position of the product region and a position of the shelf label region, in which
the correspondence identification processing includes
identifying two of the shelf labels adjacent to each other, and identifying the product region associated to each of the shelf labels by setting a boundary indicating a separation of types of the products in the product region for each of the product regions associated to an upper region of each of the two shelf labels or between the two shelf labels.

As still further aspect of the present invention, a program that causes at least one or more computers to execute the method of the above aspect may be used, or a computer-readable recording medium recording such a program may be used. The recording medium includes a non-transitory tangible medium.

The computer program includes a computer program code that, when executed by a computer, causes the computer to perform the information processing method on an information processing device.

Any combinations of the above components and modifications of the expressions of the present invention in methods, devices, systems, recording media, computer programs, and the like are also effective as aspects of the present invention.

The various components of the present invention do not necessarily have to be independent from each other, and a plurality of components may be formed as one member, one component may be formed of a plurality of members, a certain component may be a part of another component, a part of a certain component may overlap with a part of another component, and the like.

In the method and the computer program of the present invention, a plurality of procedures is described in order, but the described order does not limit the order of executing the plurality of procedures. Therefore, when the method and the computer program of the present invention are implemented, the order of the plurality of procedures can be changed within a range in which there is no problem in content.

The plurality of procedures of the method and computer program of the present invention are not limited to being executed at individually different timings. Therefore, another procedure may occur during the execution of a certain procedure, the execution timing of a certain procedure may partially or entirely overlap with the execution timing of another procedure, or the like.

### Advantageous Effects of Invention

According to one aspect of the present invention, it is possible to obtain an information processing system, an information processing device, an information processing method, and a recording medium that improve accuracy of automatic detection of shelf allocation by image recognition.

### BRIEF DESCRIPTION OF DRAWINGS

FIG. 1 It is a diagram illustrating an outline of an information processing device according to an example embodiment.

FIG. 2 It is a flowchart illustrating an operation example of the information processing device according to the example embodiment.

FIG. 3 It is a flowchart illustrating a detailed procedure of correspondence identification processing in FIG. 2.

FIG. 4 It is a diagram conceptually illustrating a system configuration of an information processing system according to an example embodiment.

FIG. 5 It is a block diagram illustrating a hardware configuration of a computer that implements an information processing device.

FIG. 6 It is a diagram illustrating a correspondence between a product region and a shelf label region.

FIG. 7 It is a diagram illustrating an example of a data structure of shelf label region information, product region information, and correspondence information.

FIG. 8 It is a diagram illustrating correspondence identification processing in a case where a product associated to a shelf label does not exist.

FIG. 9 It is a diagram illustrating a correspondence between a product region and a shelf label region.

FIG. 10 It is a flowchart illustrating a detailed procedure of correspondence identification processing of the information processing device according to the example embodiment.

FIG. 11 It is a diagram illustrating a correspondence between a product region and a shelf label region.

FIG. 12 It is a diagram illustrating a data structure example of shelf label region information, product region information, and correspondence information.

FIG. 13 It is a functional block diagram illustrating a logical configuration example of an information processing device according to an example embodiment.

FIG. 14 It is a flowchart illustrating an operation example of the information processing device according to the example embodiment.

FIG. 15 It is a flowchart illustrating a detailed procedure of product identification processing of FIG. 14.

FIG. 16 It is a diagram illustrating a data structure example of shelf label region information, product region information, and correspondence information.

FIG. 17 It is a diagram illustrating an example of a data structure of product feature information 160.

FIG. 18 It is a functional block diagram illustrating a logical configuration example of an information processing device according to an example embodiment.

FIG. 19 It is a flowchart illustrating a detailed procedure of product identification processing.

FIG. 20 It is a functional block diagram illustrating a logical configuration example of an information processing device according to an example embodiment.

FIG. 21 It is a diagram illustrating an example of a screen.

FIG. 22 It is a functional block diagram illustrating a logical configuration example of an information processing device according to an example embodiment.

FIG. 23 It is a diagram illustrating an example of a screen.

FIG. 24 It is a diagram illustrating an example of a screen.

### EXAMPLE EMBODIMENTS

Hereinafter, example embodiments of the present invention will be described with reference to the drawings. In all the drawings, the same components are denoted by the same reference numerals, and the description thereof will be omitted as appropriate. In each of the following drawings, a configuration of a portion not involved in the essence of the present invention is omitted and not illustrated.

In the example embodiment, the “acquisition” includes at least one of an own device going to obtain data or information stored in another device or a storage medium (active acquisition) and an own device receiving data or information output from another device (passive acquisition). Examples of the active acquisition include requesting or inquiring another device and receiving a reply thereto, and accessing and reading another device or a storage medium. Examples of the passive acquisition include reception of information distributed (alternatively, transmission, push notification, and the like). The “acquisition” may be selecting and acquiring from among received data or information, or selecting and receiving distributed data or information.

### Minimum Configuration Example

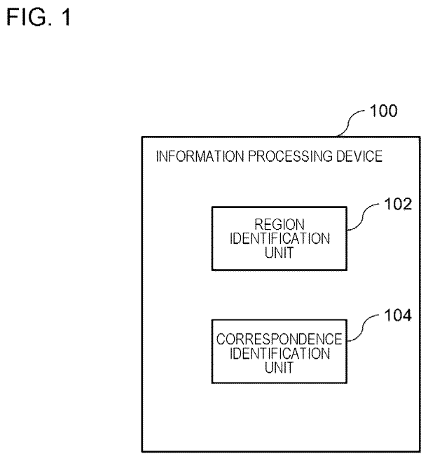

FIG. 1 is a diagram illustrating an outline of an information processing device 100 according to an example embodiment. The information processing device 100 includes a region identification unit 102 and a correspondence identification unit 104.

The region identification unit 102 identifies a product region for each product and identifies a shelf label region which is a region including a shelf label by analyzing an image including a product shelf.

The correspondence identification unit 104 identifies the product region associated to a shelf label based on a positional relationship between a position of the product region and a position of the shelf label region.

The correspondence identification unit 104 identifies two adjacent shelf labels, and identifies the product region associated to each shelf label by setting a boundary indicating a separation of types of products in a product region for each product region associated to an upper region of each of the two shelf labels or between the two shelf labels.

### Operation Example

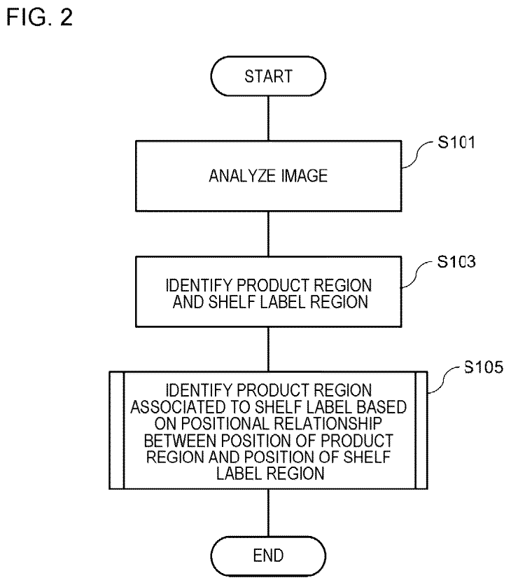

FIG. 2 is a flowchart illustrating an operation example of the information processing device 100 according to the example embodiment.

The region identification unit 102 analyzes the image including the product shelf (step S101). The region identification unit 102 identifies a product region for each product by analyzing the image, and identifies a shelf label region which is a region including a shelf label (step S103).

Then, the correspondence identification unit 104 identifies the product region associated to the shelf label based on the positional relationship between the position of the product region and the position of the shelf label region (step S105).

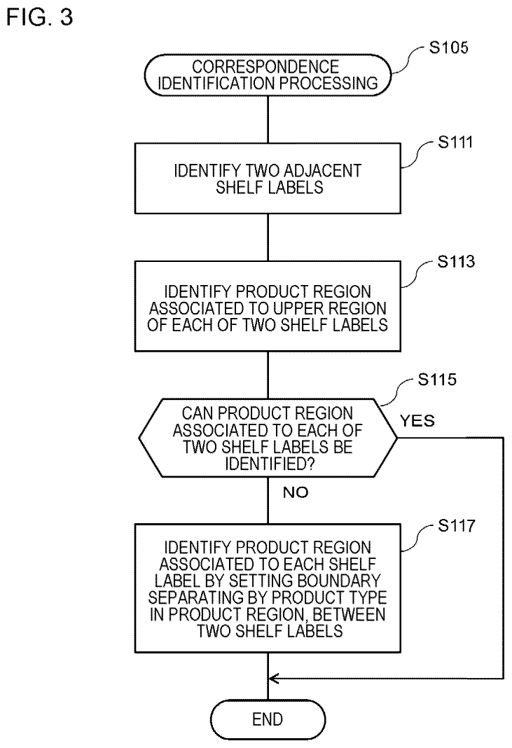

FIG. 3 is a flowchart illustrating a detailed procedure of correspondence identification processing by the correspondence identification unit 104 in step S105 in FIG. 2.

The correspondence identification unit 104 identifies two adjacent shelf labels (step S111). Then, the correspondence identification unit 104 identifies a product region associated to an upper region of each of the two shelf labels (step S113). In a case where the product region associated to the upper region of each of the two shelf labels has not been able to be identified (NO in step S115), the correspondence identification unit 104 identifies the product region associated to each shelf label by setting a boundary indicating a separation of types of products in the product region between the two shelf labels (step S117). In a case where the product region associated to the upper region of each of the two shelf labels can be identified (YES in step S115), this processing is ended while bypassing step S117.

According to the information processing device 100, it is possible to obtain an effect of improving accuracy of automatic detection of shelf allocation by image recognition.

Hereinafter, a detailed example of the information processing device 100 will be described.

### First Example Embodiment

### System Overview

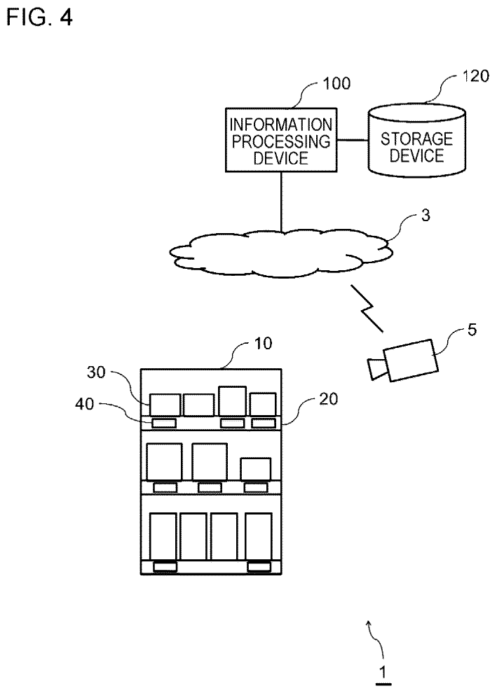

FIG. 4 is a diagram conceptually illustrating a system configuration of an information processing system 1 according to an example embodiment.

The information processing system 1 includes a camera 5 that captures an image of a product shelf 10, and an information processing device 100. The information processing device 100 and the camera 5 are connected via a communication network 3. The information processing device 100 is a computer such as a personal computer or a server computer. The computer will be described later.

The information processing device 100 includes a storage device 120. The storage device 120 may be provided inside the information processing device 100 or may be provided outside. That is, the storage device 120 may be hardware integrated with the information processing device 100 or may be hardware separate from the information processing device 100.

The camera 5 includes a lens and an imaging element such as a charge coupled device (CCD) image sensor, and is, for example, a network camera such as an Internet protocol (IP) camera. The network camera has, for example, a wireless local area network (LAN) communication function, and is connected to the information processing device 100 via a relay device (not illustrated) such as a router of the communication network 3. The camera 5 may be, for example, a security or surveillance camera installed in a store, or may be a camera installed at a position facing the product shelf 10, an upper region of the product shelf 10, an upper region of each shelf board 20 of the product shelf 10, or the like in order to capture an image of the product shelf 10. Then, the camera 5 may include a mechanism for controlling the orientation of the camera body or the lens, zoom control, focusing, and the like.

The camera 5 may be a camera of a mobile terminal such as a smartphone. In this case, an image captured by an operator such as a clerk using the camera of the mobile terminal is transmitted to the information processing device 100.

The image generated by the camera 5 may be captured in real time and transmitted to the information processing device 100, may not be directly transmitted from the camera 5 to the information processing device 100, or may be an image delayed by a predetermined time. The image captured by the camera 5 may be temporarily stored in another storage device (not illustrated), and the information processing device 100 may read the image sequentially or at predetermined intervals from the storage device. The image transmitted to the information processing device 100 may be a moving image, a frame image at predetermined intervals, or a still image.

In a case where the camera of the mobile terminal is used as the camera 5, an application for image acquisition may be installed in the mobile terminal in advance, and the image acquisition processing may be achieved by activating the application on the mobile terminal. Specifically, the application executes processing of causing the operator to capture an image of the product shelf 10 using the camera of the mobile terminal and processing of transmitting an image generated by the camera of the mobile terminal to the information processing device 100.

### Hardware Configuration Example

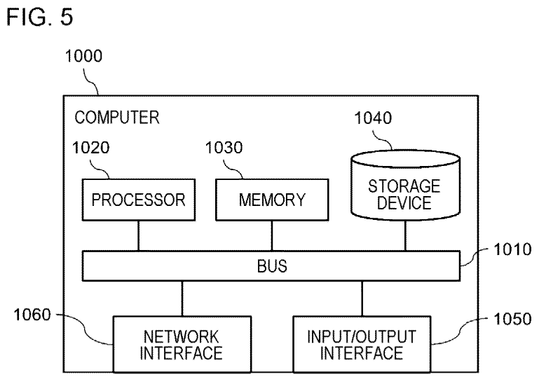

FIG. 5 is a block diagram illustrating a hardware configuration of a computer 1000 that implements the information processing device 100. The mobile terminal described above is also achieved by the computer 1000.

The computer 1000 includes a bus 1010, a processor 1020, a memory 1030, a storage device 1040, an input/output interface 1050, and a network interface 1060.

The bus 1010 is a data transmission path for the processor 1020, the memory 1030, the storage device 1040, the input/output interface 1050, and the network interface 1060 to transmit and receive data to and from each other. However, the method of connecting the processor 1020 and the like to each other is not limited to the bus connection.

The processor 1020 is a processor achieved by a central processing unit (CPU), a graphics processing unit (GPU), or the like.

The memory 1030 is a main storage device achieved by a random access memory (RAM) or the like.

The storage device 1040 is an auxiliary storage device achieved by a hard disk drive (HDD), a solid state drive (SSD), a memory card, a read only memory (ROM), or the like. The storage device 1040 stores a program module that achieves each function (for example, the region identification unit 102, the correspondence identification unit 104, and a product identification unit 106, a storage processing unit 108, an output processing unit 110, a display processing unit 112 to be described later, and the like) of the information processing device 100. The processor 1020 reads and executes the program modules on the memory 1030, thereby implementing the functions associated to the program modules. The storage device 1040 may also store each data of the storage device 120 of the information processing device 100.

The program module may be recorded in a recording medium. The recording medium that records the program module includes a non-transitory tangible medium that can be used by the computer 1000, and a program code readable by the computer 1000 (processor 1020) may be embedded in the medium.

The input/output interface 1050 is an interface for connecting the computer 1000 and various input/output devices. The input/output interface 1050 also functions as a communication interface that performs a near field communication (NFC) such as Bluetooth (registered trademark) or near field communication (NFC) such as Bluetooth (registered trademark).

The network interface 1060 is an interface for connecting the computer 1000 to a communication network. The communication network is, for example, a local area network (LAN) or a wide area network (WAN). A method of connecting the network interface 1060 to the communication network may be a wireless connection or a wired connection.

The computer 1000 is connected to a necessary device (for example, an operation unit such as an operation button, a keyboard, or a mouse, a display, a camera, a speaker, a microphone, or a printer) via the input/output interface 1050 or the network interface 1060.

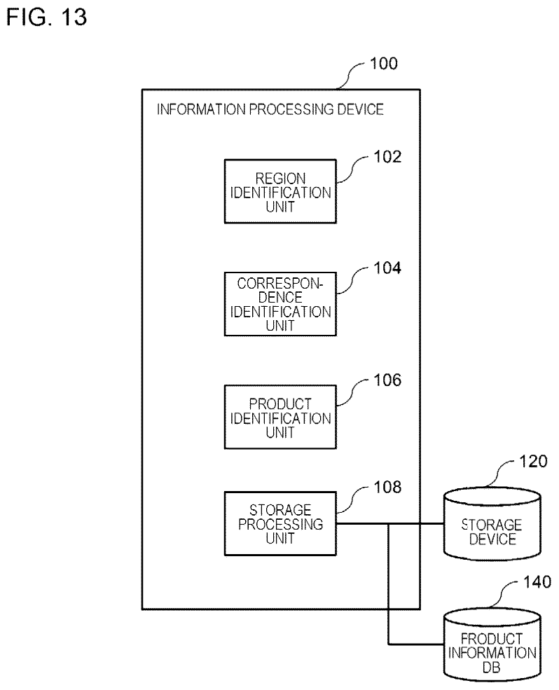

Each component of the information processing device 100 of each example embodiment in FIG. 1 and FIGS. 13, 18, 20, and 22 to be described later is achieved by any combination of hardware and software of the computer 1000 in FIG. 5. Those skilled in the art will understand that there are various modifications of the implementation method and device. The functional block diagram illustrating the information processing device 100 of each example embodiment illustrates a logical functional unit block instead of a hardware unit configuration.

### Functional Configuration Example

Hereinafter, a functional configuration example of the information processing device 100 according to the example embodiment will be described with reference to FIG. 1.

The information processing device 100 includes a region identification unit 102 and a correspondence identification unit 104.

As illustrated in FIG. 4, the product shelf 10 includes a plurality of shelf boards 20. Products 30 are placed and displayed on the respective shelf boards 20. Shelf labels 40 associated to the displayed products 30 are installed on the shelf boards 20. In the present example embodiment, as an example of the installation position of the shelf label 40, an example in which the shelf label 40 is installed on a front surface of the shelf board 20 at a position below the product 30 will be described. However, the installation position of the shelf label 40 is not limited thereto, and may be above the product 30 or to the left or right of the product 30. The installation position of the shelf label 40 may be any position as long as the customer is notified of the association with the relevant product 30.

The region identification unit 102 identifies a product region for each product 30, and identifies a shelf label region which is a region including the shelf label 40 by analyzing an image including the product shelf 10.

The image analysis processing may be performed by an image processing device (not illustrated) connected to the information processing device 100 directly or via the communication network 3. The image processing device may be included in the information processing device 100.

The region identification unit 102 first identifies the region of the product shelf 10 by analyzing the image including the product shelf 10, identifies an upper region of each shelf board 20 included in the identified region of the product shelf 10, and further identifies the product region of the product 30 in the upper region of each shelf board 20. The product region for each product 30 is, for example, a so-called “face” region of the product 30, and is a region defined by a product frame indicating a boundary between the product 30 and a region other than the product 30.

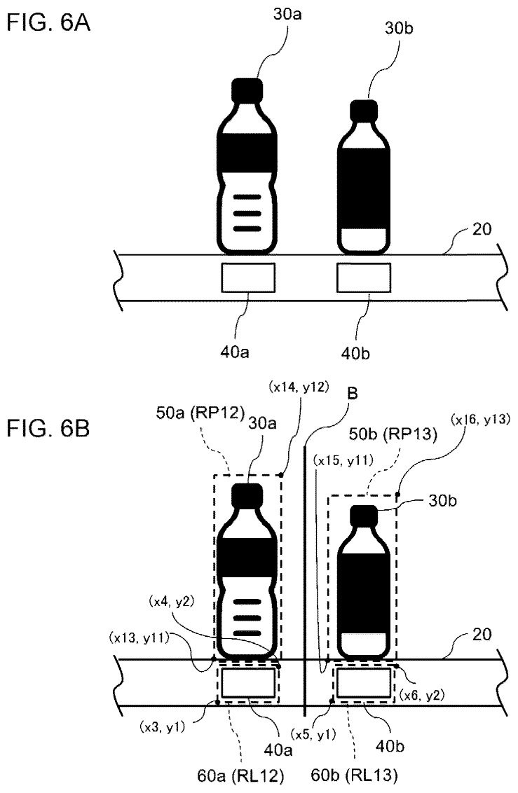

FIG. 6 is a diagram illustrating a correspondence between a product region and a shelf label region. FIG. 6 illustrates a part of the shelf board 20.

As illustrated in FIG. 6(a), two products 30a and 30b are displayed on the shelf board 20. Then, a shelf label 40a and a shelf label 40b respectively associated to the product 30a and the product 30b are installed on shelf board 20.

FIG. 6(b) illustrates a product region 50 and a shelf label region 60 identified by the correspondence identification unit 104.

The correspondence identification unit 104 analyzes the image to identify a product region 50a of the product 30a, a product region 50b of the product 30b, a shelf label region 60a of the shelf label 40a, and a shelf label region 60b of the shelf label 40b.

In the example of FIG. 6(b), a position of each region is indicated by the coordinates of the lower left and upper right of a rectangular region indicated by a broken line. However, the position of each region can be indicated by other methods, for example, may be indicated by barycentric coordinates of the region. In the drawing, the shelf label region 60 is outside the shelf label 40, but may be at least partially matched with the shelf label 40, or at least partially inside the shelf label 40.

The correspondence identification unit 104 first identifies two adjacent shelf labels 40a and 40b (specifically, shelf label region 60a and shelf label region 60b) among the identified shelf labels 40. Then, the correspondence identification unit 104 identifies the product region 50a and the product region 50b associated to two upper regions of the shelf label region 60a of the shelf label 40a and the shelf label region 60b of the shelf label 40b, respectively.

The relationship between the shelf label 40 and the product 30 includes a case where the shelf label 40 and the product 30 correspond one-to-one, and a case where at least two or more faces of the product 30 are arranged on the shelf board 20, and two or more products 30 are associated to one shelf label 40. In a case where the product 30 is out of stock, there may be a case where the product 30 associated to the shelf label 40 does not exist. In a case where the shelf label 40 and the product 30 are not associated to each other on a one-to-one basis due to movement of the product 30 or the shelf label 40, for example, the number of shelf labels 40 may be larger than the number of products 30, or the number of shelf labels 40 may be smaller than the number of products 30. In a case where the shelf label 40 is missing, there may be a case where the shelf label 40 associated to the product 30 does not exist.

In order to consider a case where the number of shelf labels 40 is smaller than the number of products 30 or a case where there is no shelf label 40 associated to the product 30, the correspondence identification unit 104 may further identify a shelf label region 60 associated to a lower region (however, in a case where the shelf label 40 is installed above the product 30, the upper region) of each of the product regions 50 of the two products 30. That is, the correspondence identification unit 104 may identify the product region 50 of the product 30 or the shelf label region 60 of the shelf label 40 associated to any one of the upper region of each of the shelf label regions 60 of two adjacent shelf labels 40 and the lower region of each of the product regions 50 of two adjacent products 30.

In the example of FIG. 6, since the product 30 exists above each shelf label 40, the correspondence identification unit 104 determines that the type of the product 30a in the identified product region 50a is different from the type of the product 30b in the product region 50b, and sets a boundary B indicating a product type separation between the product region 50a and the product region 50b. Then, the correspondence identification unit 104 associates the shelf label 40a with the product region 50a, and associates the shelf label 40b with the product region 50b.

Each product 30 has information capable of identifying the own product 30. An example of the information that can identify the product 30 is the name (product name) of the product 30. The product name may include, for example, any information of a manufacturer name, a brand name, a series name, a production region, a grade, a type (for example, in the case of bean curd, silk-filtered bean curd/cotton-filtered bean curd/baked bean curd, and the like), a type (salt taste/soy sauce taste, or soft/hard taste) such as taste, smell, or texture), an option (In the case of natto, with sauce, with mustard, or the like, or limited season, or the like), a color, and a size (for example, in the case of a beverage, 350 milliliters/500 milliliters/1 liter, or the like.) of the product 30.

For example, a product code that can uniquely identify a product can be assigned to the product 30. The product code may be, for example, a model number or the like attached to a product by a manufacturer, or may be a stock keeping unit (SKU) such as a Japanese Article Number (JAN) code (Global Trade Item Number (GTIN)). That is, another example of the information that can identify the product 30 is the product code.

Hereinafter, information (a product name or a product code) that can identify the product 30 is also referred to as “product type information”.

In the following description, the products 30 having the same product name or the same product code are products of the same type, and the products 30 having different product names or product codes are products of different types.

On the shelf label 40, in addition to the product name, price, and product code of the product 30, a code such as a barcode or a two-dimensional code (which may be a symbol or mark other than a code) indicating the product code, the position of the shelf label 40, and the like may be displayed. The region identification unit 102 may recognize a code written on the shelf label 40 by processing an image and identify the presence or installation position of the shelf label 40.

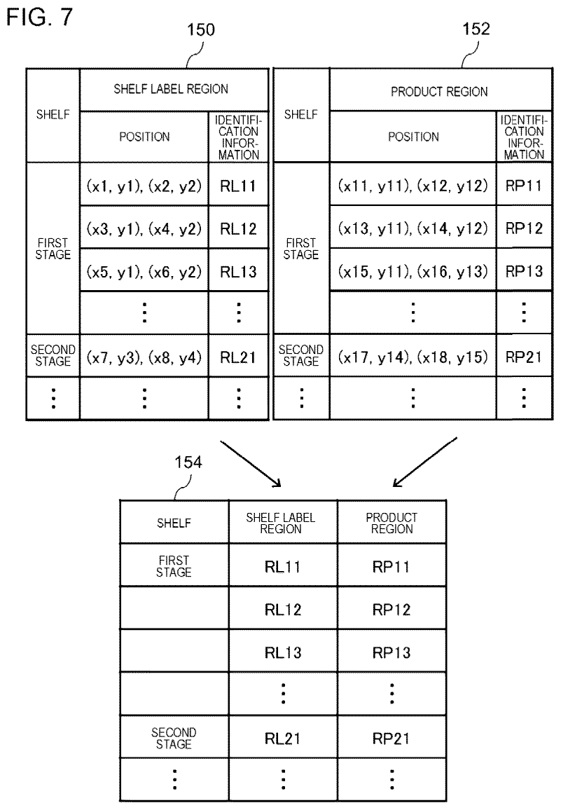

FIG. 7 is a diagram illustrating a data structure example of a shelf label region information 150, a product region information 152, and a correspondence information 154. The shelf label region information 150, the product region information 152, and the correspondence information 154 are stored in the storage device 120.

The shelf label region information 150 includes information regarding the shelf label region 60 of the shelf label 40 installed on each shelf board 20 for each product shelf 10. The information regarding the shelf label region 60 of the shelf label 40 includes information indicating the position of the shelf label region 60 and information for identifying the shelf label region 60. Information uniquely determined for each shelf label region 60 may be allocated to the information for identifying the shelf label region 60 when the correspondence identification unit 104 identifies the shelf label region 60. Alternatively, as described in an example embodiment to be described later, the information for identifying the shelf label region 60 may be product type information (for example, a product name or a product code) of the product 30 identified based on product type information (for example, a product name or a product code) of the product 30 displayed on the shelf label 40 included in the shelf label region 60.

In FIG. 7, the information for identifying each shelf board 20 is “first stage” and “second stage”, but the present invention is not limited thereto. In another example, the information may be identification information in which uniquely determined information is allocated to each shelf board 20.

The product region information 152 includes information regarding the product region 50 of the product 30 displayed on each shelf board 20 for each product shelf 10. The information regarding the product region 50 of the product 30 includes information indicating the position of the product region 50 and information for identifying the product region 50.

Information uniquely determined for each product region 50 may be allocated to the information for identifying the product region 50 when the correspondence identification unit 104 identifies the product region 50. Alternatively, as described in an example embodiment to be described later, the information for identifying the product region 50 may be product type information (for example, a product name or a product code) of the product 30 identified by analyzing the image of the product 30 included in the product region 50.

The correspondence information 154 includes the shelf label region 60 of the shelf label 40 installed on each shelf board 20 for each product shelf 10 and the product region 50 of the product 30 displayed on each shelf board 20 in association with each other.

In the correspondence information 154, as identified by the correspondence identification unit 104, the product region 50a (RP12) of the product 30a and the shelf label region 60a (RL12) of the shelf label 40a are associated, and the product region 50b (RP13) of the product region 50b and the shelf label region 60b (RL13) of the shelf label 40b are associated.

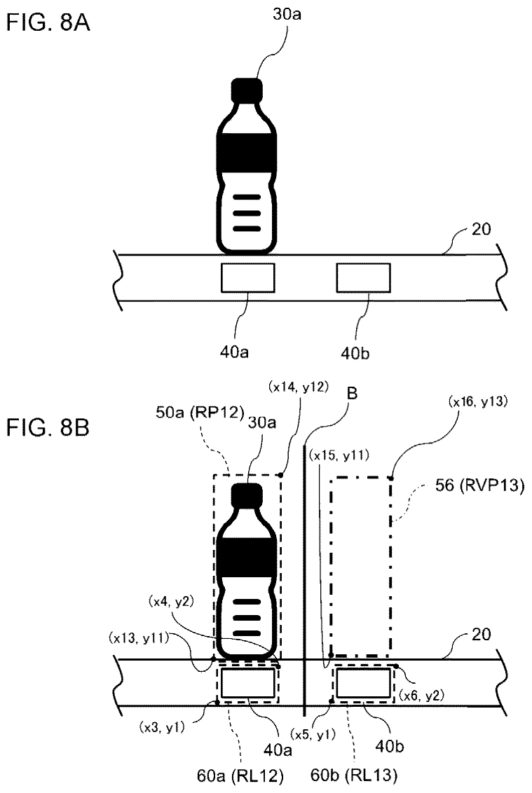

FIG. 8 is a diagram illustrating correspondence identification processing in a case where the product 30 associated to the shelf label 40b does not exist.

FIG. 8(a) illustrates a state in which only one product 30a is displayed on the shelf board 20 and the product 30b is out of stock. Then, on the shelf board 20, the shelf label 40a and the shelf label 40b respectively associated to the product 30a and the product 30b that is not currently displayed are installed.

As illustrated in FIG. 8(b), the correspondence identification unit 104 analyzes the image to identify the product region 50a of the product 30a, the shelf label region 60a of the shelf label 40a, and the shelf label region 60b of the shelf label 40b. The correspondence identification unit 104 first identifies two adjacent shelf labels 40a and 40b (specifically, shelf label region 60a and shelf label region 60b) among the identified shelf labels 40. Then, the correspondence identification unit 104 identifies the product region 50 associated to two upper regions of the shelf label region 60a of the shelf label 40a and the shelf label region 60b of the shelf label 40b. In this example, the product region 50a associated to the shelf label region 60a of the shelf label 40a is identified, but the product region 50 associated to the shelf label region 60b of the shelf label 40b is not identified.

Therefore, the correspondence identification unit 104 identifies a region 56 (in the figure, indicated by a one-dot chain line) above the shelf label region 60b of the shelf label 40b as a product region to be associated with the shelf label region 60b of the shelf label 40b. In the example of FIG. 8(b), identification information of “RVP 13” is allocated to the region 56. This identification information includes, for example, information “V” indicating that the region 56 is a region where the product 30 does not exist. However, in another example, information (for example, a flag or the like) indicating that the region 56 is a region where the product 30 does not exist may be stored in association with the product region information 152 separately from the identification information. The region 56 may be set in advance as a template (a width is a width of the shelf label 40, and a height is a height of the upper region of the shelf label 40) in accordance with the size (height) of the upper region of the shelf label 40 for each shelf board 20.

As described above, in the correspondence identification processing by the correspondence identification unit 104, when the product 30 does not exist on at least one of the upper regions of two adjacent shelf labels 40 (that is, at least one of the products 30 is out of stock), the correspondence identification unit 104 sets the boundary B indicating the separation of the types of products in the product region 50 between two adjacent shelf labels 40a and 40b (specifically, between the shelf label region 60a and the shelf label region 60b). Then, the correspondence identification unit 104 stores the shelf label 40a in association with the product region 50a, and the shelf label 40b in association with the region 56 in the correspondence information 154.

In another example, the correspondence identification unit 104 may store, in the correspondence information 154, information indicating that the product region 50 associated to the shelf label 40b does not exist.

### Operation Example

Hereinafter, an operation example of the information processing device 100 according to the example embodiment will be described with reference to FIGS. 2 and 3.

As illustrated in FIG. 2, first, the region identification unit 102 analyzes an image including a product shelf (step S101). The region identification unit 102 identifies the product region 50 for each product 30 by analyzing the image, and identifies the shelf label region 60 which is a region including the shelf label 40 (step S103). The region identification unit 102 stores information regarding the identified product region 50 and the shelf label region 60 in the product region information 152 and the shelf label region information 150, respectively.

Then, the correspondence identification unit 104 performs the correspondence identification processing in FIG. 3 for identifying the product region 50 associated to the shelf label region 60 of the shelf label 40 based on a positional relationship between the position of the product region 50 and the position of the shelf label region 60 (step S105).

As illustrated in FIG. 3, in the correspondence identification processing in step S105, first, the correspondence identification unit 104 identifies the shelf label regions 60 of two adjacent shelf labels 40 (step S111). Then, the correspondence identification unit 104 identifies the product region 50 associated to an upper region (for example, the region 56 in FIG. 8(b)) of each of the two shelf labels 40 (specifically, the shelf label region 60 of the shelf label 40) (step S113).

The correspondence identification unit 104 stores the product regions 50 associated to the shelf label regions 60 of the shelf labels 40 in association with each other in the correspondence information 154. As described above, in a case where the product region 50 associated to the upper region 56 of each of the two shelf labels 40 can be identified (YES in step S115), this processing is ended while bypassing step S117.

On the other hand, in a case where the product region 50 associated to the upper region 56 of each of the two shelf labels 40 cannot be identified (NO in step S115), the correspondence identification unit 104 identifies the product region 50 or the region 56 associated to each shelf label 40 by setting a boundary B indicating a separation in type of the product 30 in the product region 50 between the two shelf labels 40 (step S117). The correspondence identification unit 104 stores the product region 50 or the region 56 associated to each of the shelf label regions 60 of the shelf label 40 in association with each other in the correspondence information 154.

As described above, according to the present example embodiment, the information processing device 100 includes the region identification unit 102 and the correspondence identification unit 104. The region identification unit 102 identifies a product region for each product and identifies a shelf label region which is a region including a shelf label by analyzing an image including a product shelf. The correspondence identification unit 104 identifies the product region associated to a shelf label based on a positional relationship between a position of the product region and a position of the shelf label region. The correspondence identification unit 104 identifies two adjacent shelf labels, and identifies the product region associated to each shelf label by setting a boundary indicating a separation of types of products in a product region for each product region associated to an upper region of each of the two shelf labels or between the two shelf labels.

As described above, according to the information processing device 100 of the present example embodiment, the product regions 50 and the shelf label regions 60 separately identified are associated for each product region 50 associated to an upper region of each shelf label region 60 based on each positional relationship. Even in a case where the positional relationship between the product region 50 and the shelf label region 60 cannot be identified on a one-to-one basis, the information processing device 100 can identify the product region associated to each shelf label by setting a boundary indicating a separation in types of products in the product region between two shelf labels by the correspondence identification unit. In the present example embodiment, not only the product region 50 and the shelf label region 60 can be independently associated with each other to configure the correspondence information 154, but also the data can be verified in a case where the product 30 is identified by image processing. In a case where the product 30 is identified by image processing, the product 30 needs to be shown in the image. However, according to the present example embodiment, the correspondence information 154 can be correctly configured even in a case where a product is out of stock.

The case where the positional relationship between the product region 50 and the shelf label region 60 cannot be identified on a one-to-one basis includes a case where a plurality of product regions 50 exists in a region above the shelf label region 60, a case where only a part of the product region 50 is included in a region above the shelf label region 60, a case where the same product region 50 exists in both regions above the two shelf label regions 60, a case where no product exists above the shelf label region 60, and the like.

For example, different types of products of the same series are displayed adjacent to each other on the shelf board 20 in many cases in addition to low recognition accuracy due to similar packages. In such a case, determination as to whether adjacent products are of the same type by image analysis is considered to have a high probability of erroneous recognition. Therefore, in the present example embodiment, first, the position of the product region 50 is identified, and the shelf label region 60 and the product region 50 are associated based on the positional relationship with the shelf label region 60, in such a way that it is possible to prevent a decrease in association accuracy due to erroneous recognition of the product type.

For example, in a case where stockout occurs, there is a possibility that the detection accuracy of the shelf allocation by the image recognition is lowered. However, in the present example embodiment, even in a case where stockout occurs, the information processing device 100 can identify the product region 50 associated to each shelf label 40 by setting a boundary indicating a separation in types of products in the product region 50 between two adjacent shelf labels 40 by the correspondence identification unit 104. This makes it possible to improve the detection accuracy of the shelf allocation even in a case where stockout occurs.

Then, in the information processing device 100 of the present example embodiment, since it is not necessary to identify the product type of the product region 50 for all the product regions 50, the processing can be simplified and the processing load can be reduced.

### Second Example Embodiment

In the above example embodiment, the shelf label 40 and the product region 50 are associated using the positional relationship between the shelf label region 60 of the shelf label 40 and the product region 50. On the other hand, in a case where the correspondence between the shelf label 40 and the product region 50 is not on a one-to-one basis, for example, in a case where a plurality of products 30 of the same type are displayed side by side on the shelf board 20, the shelf label region 60 of one shelf label 40 is identified with respect to the plurality of product regions 50. The present example embodiment is further different from the above example embodiment in that the present example embodiment has a configuration in which a correspondence between a plurality of adjacent product regions 50 and shelf labels 40 is identified by comparing a plurality of adjacent product regions 50 by performing image analysis. The configuration of the present example embodiment may be combined with at least any one of the configurations of other example embodiments as long as no contradiction occurs.

### Functional Configuration Example

Hereinafter, a functional configuration example of the information processing device 100 according to the example embodiment will be described with reference to FIG. 1.

In a case where there are three or more product regions 50 in the upper region 56 of each of the adjacent shelf labels 40 and the upper area 52 including the two regions 56, the correspondence identification unit 104 analyzes the image and compares the adjacent product regions 50, thereby identifying the product region 50 associated to each shelf label 40.

In the present example embodiment, the shelf label 40 is described as being installed below the product region 50, but as described above, the positional relationship between the shelf label 40 and the product region 50 is not limited thereto. For example, in a case where the shelf label 40 is installed above the product region 50, the correspondence identification unit 104 identifies a lower region of each of the adjacent shelf labels 40 and a lower area including the two regions, and compares the product regions 50.

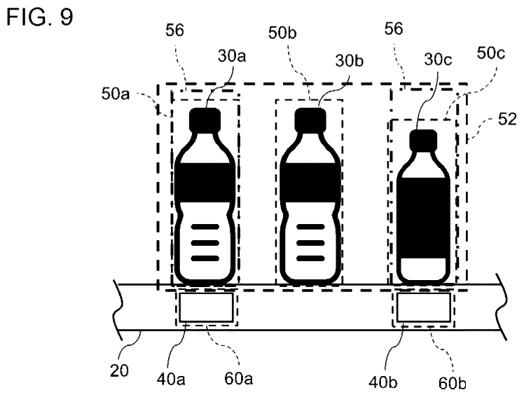

FIG. 9 is a diagram illustrating a correspondence between a product region and a shelf label region. FIG. 9 illustrates a part of the shelf board 20.

FIG. 9 illustrates that there are three or more product regions 50a, 50b, and 50c in two regions 56 above each of two adjacent shelf labels 40a and 40b and an upper area 52 including the two regions 56.

First, the correspondence identification unit 104 associates the product region 50a included in the region 56 above the shelf label region 60a of the shelf label 40a with the shelf label region 60a. Next, the correspondence identification unit 104 associates the product region 50c included in the region 56 above the shelf label region 60b of the shelf label 40b with the shelf label region 60b. On the other hand, the region 52 further includes the product region 50b. At this time point, the product region 50b is not yet associated with the shelf label region 60.

In the case illustrated in FIG. 9, for example, the correspondence identification unit 104 of the present example embodiment identifies which of the two shelf labels 40a and 40b the product region 50b corresponds to by analyzing an image and comparing the product regions 50.

A product comparison method will be described below.

### Comparative Method Example 1

The correspondence identification unit 104 calculates similarity (for example, indicated in percentage) between the product region 50a and the product region 50b by analyzing the images of the product region 50a and the product region 50b. The correspondence identification unit 104 further calculates the similarity between the product region 50b and the product region 50c by analyzing the images of the product region 50b and the product region 50c.

The correspondence identification unit 104 identifies that the product region 50 having the higher calculated similarity and the product region 50b have the same product type, and associates the product region 50b with the shelf label region 60 associated with the product region 50 having the higher similarity. That is, when the similarity between the product region 50a and the product region 50b is larger than the similarity between the product region 50b and the product region 50c, the correspondence identification unit 104 identifies that the product region 50b is the same product type as the product region 50a. Then, the correspondence identification unit 104 associates the product region 50b with the shelf label region 60a associated with the product region 50a, which has high similarity, and stores the associated product region in the correspondence information 154.

### Comparative Method Example 2

The correspondence identification unit 104 identifies that the product 30 is the same type as the product region 50 having the calculated similarity equal to or more than a threshold. In a case where both the similarities are less than the threshold, there is a possibility that the product 30 is of a type different from any of the product regions 50. Therefore, the correspondence identification unit 104 may store information indicating that the associated product type cannot be identified in the correspondence information 154. On the other hand, in a case where both the similarities are equal to or more than the threshold, as described above, it is identified that the product type is the same as the product region 50 having the higher similarity.

In a case where both similarities are less than the threshold, the correspondence identification unit 104 may identify a product by performing image analysis of the shelf label region 60 described in an example embodiment described later. Alternatively, as described in an example embodiment to be described later, the correspondence identification unit 104 may identify the product type of the product region 50 by image recognition processing using the product image registered in a product information database using the product information database.

In the above example, the correspondence identification unit 104 associates the shelf label 40 with the product 30 on the upper region thereof, and then calculates the similarity between the three adjacent left and right products 30 to identify the type of the product 30. In another example, the correspondence identification unit 104 may calculate the similarity between at least two adjacent product regions 50, determine whether the product types of the respective product regions 50 are the same based on the similarity, set a boundary indicating a product type separation in the product region 50, and then identify the shelf label region 60 associated to the product region 50 for each type.

### Operation Example

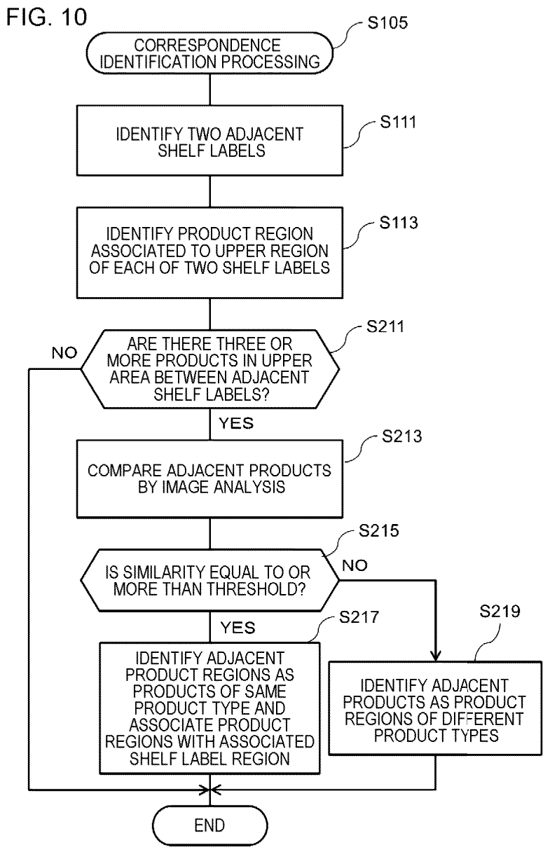

Since the basic operation of the information processing device 100 of the present example embodiment is the same as that of the above example embodiment, an operation example of the information processing device 100 according to the example embodiment will be described below with reference to FIG. 2. FIGS. 10 to 12 are also used for description.

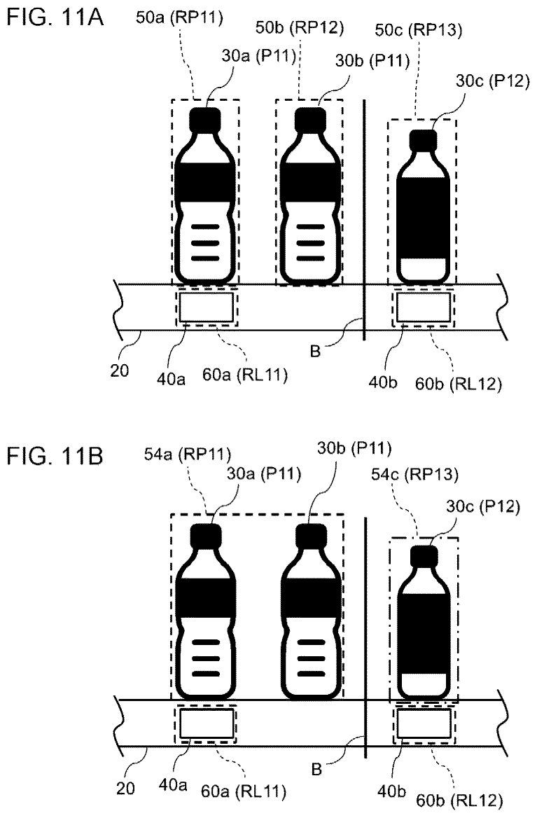

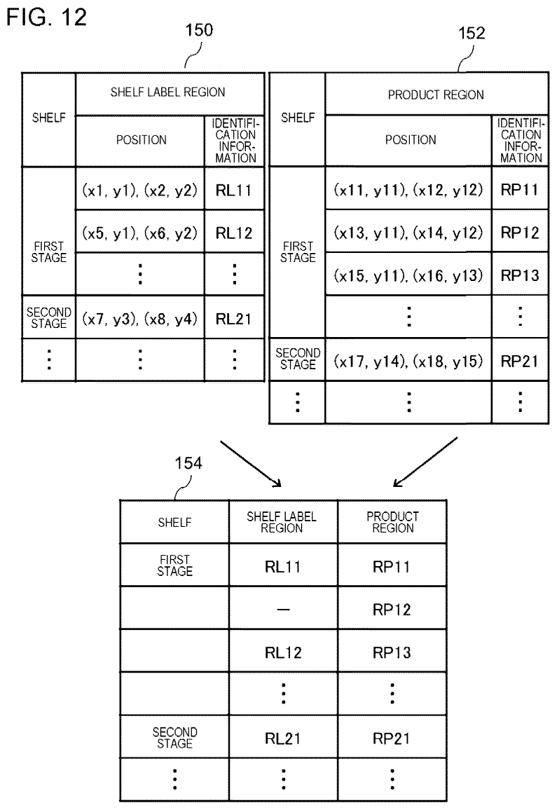

FIG. 10 is a flowchart illustrating a detailed procedure of the correspondence identification processing of the information processing device 100 according to the example embodiment. FIG. 11 is a diagram illustrating a correspondence between the product region and the shelf label region. FIG. 11 illustrates a part of the shelf board 20. FIG. 12 is a diagram illustrating a data structure example of shelf label region information 150, product region information 152, and correspondence information 154.

As illustrated in FIG. 2, first, the region identification unit 102 analyzes an image including a product shelf (step S101). The region identification unit 102 identifies the product region 50 for each product 30 by analyzing the image, and identifies the shelf label region 60 which is a region including the shelf label 40 (step S103). As illustrated in FIG. 11(a), the region identification unit 102 identifies the product region 50a, the product region 50b, the product region 50c, the shelf label 40a, and the shelf label 40b. The region identification unit 102 stores, as illustrated in FIG. 12, information regarding the identified product region 50 and the shelf label region 60 in the product region information 152 and the shelf label region information 150, respectively.

Then, the correspondence identification unit 104 identifies the product region associated to the shelf label based on the positional relationship between the position of the product region and the position of the shelf label region (step S105). The correspondence identification processing in step S105 will be described with reference to FIG. 10.

A flow of FIG. 10 includes steps S111 and S113 that are the same as the flow of FIG. 3, and further includes steps S211 to S219. FIG. 10 illustrates an example of performing comparison by the method of Comparative Method Example 2 described above.

The correspondence identification unit 104 identifies two adjacent shelf labels, that is, the shelf label 40a and the shelf label 40b as illustrated in FIGS. 9 and 11(a) (step S111). Then, the correspondence identification unit 104 identifies the product region 50a and the product region 50c associated to the upper region 56 of each of the two shelf labels 40a and 40b (step S113). The correspondence identification unit 104 stores the identified shelf label region 60 and product region 50 in association with each other in the correspondence information 154. In the example of FIG. 12, the shelf label region 60a (RL11) is associated with the product region 50a (RP11), and the shelf label region 60b (RL12) is associated with the product region 50c (RP13). On the other hand, the shelf label region 60 is not associated with the product region 50b (RP12).

The correspondence identification unit 104 determines whether there are three or more product regions 50 in the upper region 56 of each of the adjacent shelf labels 40 and the upper area 52 including the two regions 56 (step S211). Then, when there are three or more product regions 50 in the upper region 56 of each of the adjacent shelf labels 40 and the upper area 52 including the two regions 56 (YES in step S211), the correspondence identification unit 104 analyzes the image and compares the adjacent product regions 50 (step S213). On the other hand, when there are not three or more product regions 50 in the upper region 56 of each of the adjacent shelf labels 40 and the upper area 52 including the two regions 56 (NO in step S211), this processing ends while bypassing steps S213 to S219. That is, the correspondence identified in step S113 is adopted.

In the example of FIGS. 9 and 11(a), since there are three or more product regions 50 in the upper region 56 of each of the adjacent shelf labels 40 and the upper area 52 including the two regions 56 (YES in step S211), the correspondence identification unit 104 analyzes the image and compares the adjacent product region 50a and product region 50b, and the adjacent product region 50b and product region 50c (step S213). The correspondence identification unit 104 calculates the similarity between the product region 50a and the product region 50b by analyzing the images of the product region 50a and the product region 50b. The correspondence identification unit 104 further calculates the similarity between the product region 50b and the product region 50c by analyzing the images of the product region 50b and the product region 50c.

Then, the correspondence identification unit 104 determines whether each similarity is equal to or more than a threshold (step S215). When the similarity is equal to or more than the threshold (YES in step S215), two adjacent product regions 50 are identified as products of the same product type. Here, when the similarity between the product region 50a and the product region 50b is equal to or more than the threshold (YES in step S215), the correspondence identification unit 104 identifies that the product region 50a and the product region 50b are regions of products of the same type, associates the product region 50b (RP12) with the shelf label region 60a (RL11) already associated with the product region 50a (RP11), and stores the correspondence in the correspondence information 154 (step S217).

Here, when the similarity between the product region 50b and the product region 50c is less than the threshold (NO in step S215), the product region 50b and the product region 50c are identified to be regions of different types of products (step S219), and the present processing is terminated.

As described above, in the information processing device 100 according to the present example embodiment, in a case where there are three or more product regions 50 in the upper region 56 of each of the adjacent shelf labels 40 and the upper area 52 including the two regions 56, the correspondence identification unit 104 identifies the product region 50 associated to each shelf label 40 by analyzing the image and comparing the adjacent product regions 50. That is, in the present example embodiment, in a case where there are three or more product regions 50 in the upper region 56 of each of the adjacent shelf labels 40 and the upper area 52 including the two regions 56, in other words, in a case where the shelf label region 60 and the product region 50 cannot be identified on a one-to-one basis from the positional relationship, the correspondence identification unit 104 identifies the product region 50 associated to each shelf label 40 by comparing the adjacent product regions 50.

As described above, according to the information processing device 100 of the present example embodiment, the same effects as those of the above example embodiment are obtained, and furthermore, in a case where the shelf label region 60 and the product region 50 cannot be identified on a one-to-one basis from the positional relationship, the product region 50 associated to the shelf label 40 can be identified.

### Third Example Embodiment

FIG. 13 is a functional block diagram illustrating a logical configuration example of an information processing device 100 according to an example embodiment. The present example embodiment is the same as at least one of the above example embodiments except that the present example embodiment has a configuration in which a product in at least one of the shelf label region 60 and the product region 50 is identified by image analysis. The configuration of the present example embodiment may be combined with at least one of configurations of other example embodiments to be described later within a range that does not cause inconsistency.

### Functional Configuration Example

The information processing device 100 further includes a product identification unit 106 and a storage processing unit 108 in addition to the configuration of the information processing device 100 of the above example embodiment in FIG. 1.

The product identification unit 106 identifies the type of each product by analyzing the image. The product identification unit 106 outputs product type information (at least one of a product name and a product code) of the identified product 30.

The storage processing unit 108 stores the product type information of the product 30 identified by the product identification unit 106 and the product region 50 (specifically, the position information of the product region 50), which are associated to the product region 50 associated with the shelf label 40 (specifically, the shelf label region 60 of the shelf label 40) by the correspondence identification unit 104, in the storage device 120 in association with each other.

The product identification unit 106 analyzes the image of the shelf label region 60 included in the image to identify the type of product associated to the shelf label 40. The product identification unit 106 outputs product type information (product name or product code) indicating the type of the identified product. The product identification unit 106 may output information (for example, a value of 0 to 100%) indicating the certainty of the identified product type. Then, in a case where a value of the information indicating the certainty is equal to or more than a threshold, the product identification unit 106 may identify that it is the product type of the product in the shelf label region 60.

For example, character information indicating a product type such as a product name or a product code, or a barcode or a two-dimensional code indicating a product type is described on the shelf label 40 included in the shelf label region 60. Therefore, the correspondence identification unit 104 analyzes the image of the shelf label region 60 to recognize the product type information (product name or product code) including the product type indicated on the shelf label 40 by reading an optical character reader (OCR), a barcode, or a two-dimensional code.

The information processing device 100 is further connected to a product information database 140. In the product information database 140, for example, information such as a product name is stored in association with a product code. The product information database 140 may further include product item information indicating a classification of products and an item (for example, large classifications such as fresh, chilled, prepared food, frozen, processed products, bread confectionery, and beverages, and medium classifications such as fresh fruit and vegetable, livestock, and fishery). The product information database 140 may store the product code in association with the registered product image (specifically, a feature amount with which a product can be recognized as an image) together with the product item information, the product name, and the like.

The product identification unit 106 may read a barcode or a two-dimensional code, acquire a product code or the like, access the product information database 140, and acquire a product name or the like associated to the product code.

The product identification unit 106 may store the acquired product type information such as the product code and the product name in the storage device 120 as the product region information 152 in association with the product region 50.

The storage processing unit 108 may further associate an image with the product region 50 and the product type information to store the information in the storage device 120 as the product feature information 160. The image may include at least the product region 50, and may further be a feature amount capable of identifying the product. The image can be used to cause a recognition model for recognizing a product to perform machine learning. The machine learning will be described in an example described later.

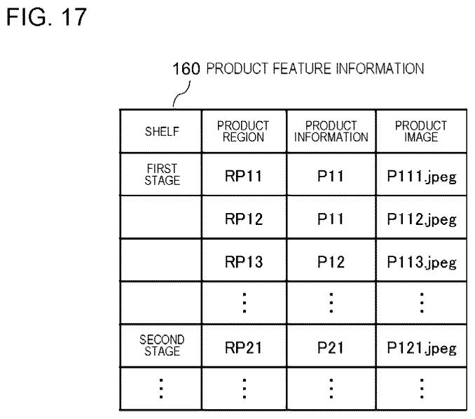

FIG. 17 is a diagram illustrating a data structure example of the product feature information 160. The product feature information 160 includes, as information on products displayed on each shelf board 20 for each product shelf 10, the product region 50 of the product, product type information identified by the product identification unit 106, and the image of the product region 50 in association with each other. The product region 50 is information that can identify the product region, and although the identification information of the product region 50 is used in the example of this figure, it may be position information of the product region 50. In this example, the image of the product region 50 is an image file, but in another example, the image may be feature information indicating a feature amount of the image of the product region 50.

Returning to FIG. 13, the storage processing unit 108 may further associate the shelf label region 60 (specifically, position information of the shelf label region 60) of the shelf label 40 associated to the product region 50 with the product region 50 and the product information, and store the associated information in the storage device 120.

The information stored in the storage processing unit 108 can be used as shelf allocation information.

The product identification unit 106 identifies a first candidate of the type of the product 30 in the product region 50 by analyzing the image of the product region 50 included in the image. The product identification unit 106 analyzes the image of the shelf label region 60 included in the image to identify a second candidate of the type of the product 30 on the shelf label 40 in the shelf label region 60.

In a case where the first candidate and the second candidate match, the storage processing unit 108 reads information (product type information such as a product code and a product name, an image of a product, and the like) related to the product of the type from the product information database 140 (product information storage means), and stores the information in the storage device 120 in association with the product region 50 (specifically, the position information of the product region 50).

### Operation Example

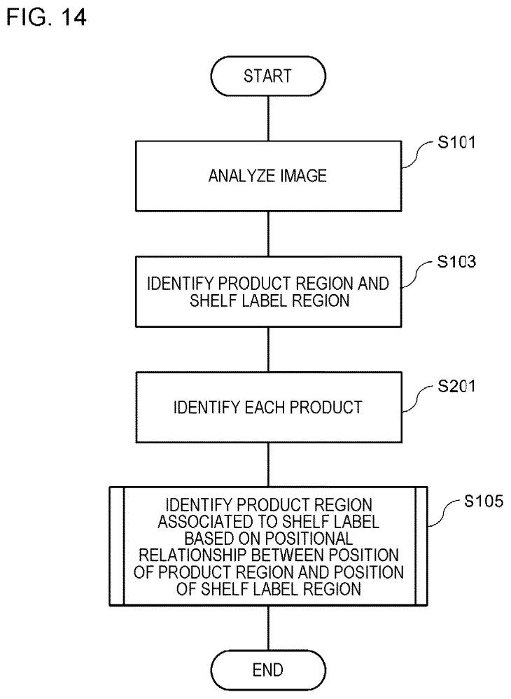

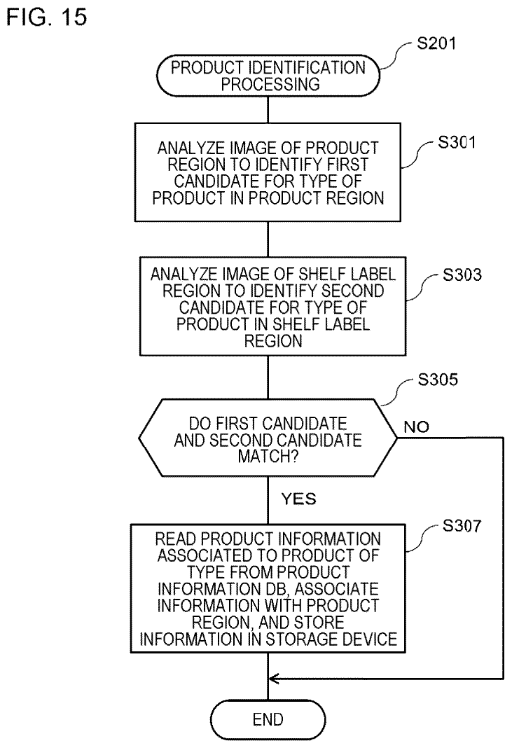

Hereinafter, the operation of the information processing device 100 will be described with reference to FIGS. 14 and 15.

FIG. 14 is a flowchart illustrating an operation example of the information processing device 100 according to the example embodiment. A flow of FIG. 14 includes steps S101 to S105 that are the same as the flow of FIG. 2, and further includes step S201 between steps S103 and S105. FIG. 15 is a flowchart illustrating a detailed procedure of the product identification processing in step S201 of FIG. 14.

As illustrated in FIG. 14, first, the region identification unit 102 analyzes an image including a product shelf (step S101). The region identification unit 102 identifies the product region 50 for each product 30 by analyzing the image, and identifies the shelf label region 60 which is a region including the shelf label 40 (step S103). As illustrated in FIG. 11(a), the region identification unit 102 identifies the product region 50a, the product region 50b, the product region 50c, the shelf label 40a, and the shelf label 40b. The region identification unit 102 stores, as illustrated in FIG. 12, information regarding the identified product region 50 and the shelf label region 60 in the product region information 152 and the shelf label region information 150, respectively.

Then, the product identification unit 106 identifies each product by analyzing the image (step S201). The product identification processing in step S201 will be described with reference to FIG. 15.

As illustrated in FIG. 15, first, an image of the product region 50 included in the image is analyzed to identify a first candidate for the type of the product 30 in the product region 50 (step S301). Then, the product identification unit 106 analyzes the image of the shelf label region 60 included in the image to identify a second candidate of the type of the product 30 on the shelf label 40 in the shelf label region 60 (step S303).

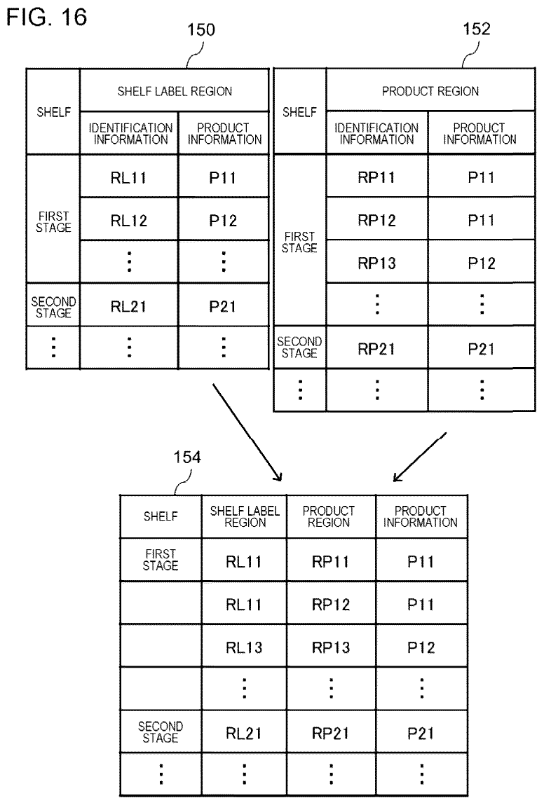

FIG. 16 is a diagram illustrating a data structure example of the shelf label region information 150, the product region information 152, and the correspondence information 154. The shelf label region information 150, the product region information 152, and the correspondence information 154 are stored in the storage device 120.

The product identification unit 106 stores the identified first candidate (product type information indicating the type of the product 30) as the product region information 152 in association with the identification information of the product region 50. The product identification unit 106 further stores the identified second candidate (product type information indicating the type of the product 30) as the shelf label region information 150 in association with the identification information of the shelf label region 60. However, the product region information 152 may include, instead of the identification information of the product region 50, information that can identify the product region 50, such as position information of the product region 50, in association with product type information indicating a product type. The shelf label region information 150 may include, instead of the identification information of the shelf label region 60, information that can identify the shelf label region 60, such as position information of the shelf label region 60, in association with product type information indicating a product type.

Returning to FIG. 15, the storage processing unit 108 determines whether the first candidate and the second candidate match (step S305). That is, it is determined whether the product type (first candidate) identified from the product region 50 matches the product type (second candidate) identified from the shelf label region 60.

When the first candidate and the second candidate match (YES in step S305), the storage processing unit 108 reads information (product type information or the like) related to the product of the type from the product information database 140, associates the information with the product region 50 (specifically, identification information of the product region 50), and stores the information in the storage device 120 (step S307). When the first candidate and the second candidate do not match (NO in step S305), this processing is ended by bypassing step S307, and the processing proceeds to step S105.

In a case where the product type is identified by the storage processing unit 108, the correspondence identification unit 104 may further associate the shelf label region 60 and the product region 50 with the product type information and store the associated information in the correspondence information 154 as illustrated in FIG. 16.

As described above, the information processing device 100 of the present example embodiment further includes the product identification unit 106 and the storage processing unit 108. The product identification unit 106 identifies each product by analyzing the image.

The storage processing unit 108 stores the product type information of the product 30 identified by the product identification unit 106 and the product region 50 (specifically, the position information of the product region 50), which are associated to the product region 50 associated with the shelf label 40 (specifically, the shelf label region 60 of the shelf label 40) by the correspondence identification unit 104, in the storage device 120 in association with each other.

As described above, according to the information processing device 100 of the present example embodiment, the same effects as those of the above-described example embodiments are obtained, and furthermore, the products in the product region 50 associated with the shelf label 40 can be identified and associated and accumulated, in such a way that the information can be used as shelf allocation information. Since the storage processing unit 108 can accumulate the product type information and the product image (feature information) as the product feature information 160 in association with each other, the information can also be used for machine learning of the product recognition model. The machine learning will be described in an example described later.

### Fourth Example Embodiment

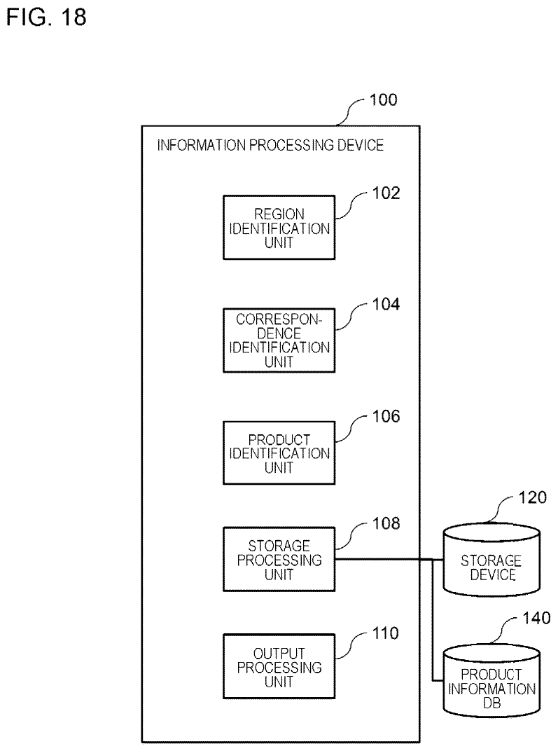

FIG. 18 is a functional block diagram illustrating a logical configuration example of an information processing device 100 according to an example embodiment. The present example embodiment is the same as the third example embodiment described above except that the present example embodiment has a configuration of outputting information indicating that a product type candidate identified from a product region 50 does not match a product type candidate identified from the shelf label region 60. The configuration of the present example embodiment may be combined with at least any one of the configurations of other example embodiments other than the third example embodiment as long as no contradiction occurs.

### Functional Configuration Example

The information processing device 100 further includes an output processing unit 110 in addition to the configuration of the information processing device 100 of FIG. 13 of the third example embodiment. When the first candidate (the type of the product 30 identified from the product region 50) and the second candidate (the type of the product 30 of the shelf label 40 identified from the shelf label region 60) do not match, the output processing unit 110 causes an output device (not illustrated) to output information indicating that the types of products in the shelf label region 60 and the product region 50 do not match.

The output device is, for example, an output means such as a display or a speaker of the information processing device 100. The output processing unit 110 causes a display to display the information on a screen or causes a speaker to output a voice message or a notification sound indicating the information. The output information may include information capable of identifying a place where the types of products in the shelf label region 60 and the product region 50 do not match, such as position information of at least one of the product shelf 10, the shelf board 20, the shelf label 40, and the product region 50 identified as the types of products in the shelf label region 60 and the product region 50 not matching each other.

The display is, for example, a liquid crystal display, an organic electro-luminescence (EL) display, or the like.

In a case where the types of products do not match each other, a screen 220 for associating the shelf label region 60 with the product region 50 may be displayed on the display by a display processing unit 112 described in an example embodiment to be described later.

In a case where the products 30 have a plurality of types and have similar packages, the plurality of product types may be identified because they cannot be discriminated from each other by image analysis. In such a case, the product identification unit 106 identifies the product type of the product region 50 with reference to the second candidate of the product type identified from the shelf label region 60 of the shelf label 40.

That is, when a plurality of first candidates is identified, the product identification unit 106 selects the type of the product of the first candidate that matches the second candidate as the type of the product in the product region 50.

For example, as illustrated in FIG. 11(a), the output processing unit 110 may cause the output device to output information indicating that there is no shelf label 40 associated to the product 30b, in a case where among the products 30a, 30b, and 30c associated with three product regions 50a, 50b, and 50c identified above two adjacent shelf labels 40a and 40b, the types of the shelf label 40a and the product 30a and the types of the shelf label 40b and the product 30c match each other, but the type of the product 30b does not match any of the types of the shelf label 40a and the shelf label 40b.

Also in this example, a display indicating a place where the shelf label 40 associated to the product 30b does not exist may be displayed on the display by the display processing unit 112 described in an example embodiment to be described later. The display processing unit 112 causes an image element identifiably indicating at least one of the product region 50b of the product 30b where the shelf label 40 does not exist and the shelf label region 60 of the shelf label 40 associated to the product 30b in such a way as to be superposed on the image. The image element may be an image element (for example, highlight, blinking, animation image, and the like) in an enhanced expression format in such a way as to be distinguishable from other regions.

### Operation Example

The information processing device 100 of the present example embodiment performs the same operation as that in FIG. 14 of the third example embodiment. The product identification processing in step S201 in FIG. 14 is different from that of the third example embodiment.

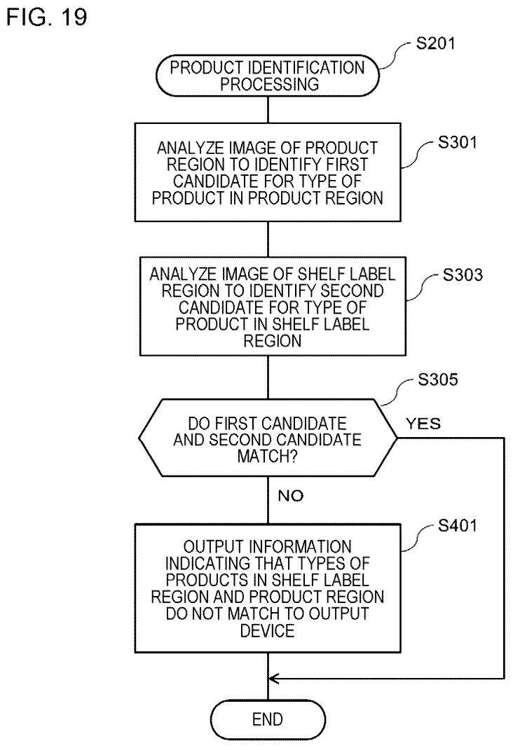

FIG. 19 is a flowchart illustrating a detailed procedure of the product identification processing according to the present example embodiment. FIG. 19 includes steps S301 to S305 that are the same as those in the flow of FIG. 15, and further includes step S401.

In the determination processing of step S305, when the first candidate and the second candidate do not match (NO of step S305), the output processing unit 110 causes the output device to output information indicating that the types of products in the shelf label region 60 and the product region 50 do not match (step S401). On the other hand, when the first candidate and the second candidate match each other (YES in step S305), this processing ends by bypassing step S401, and the processing proceeds to step S105.

The operator can recognize that the types of products in the shelf label region 60 and the product region 50 do not match based on the information output by the output processing unit 110. In a case where the information is output, for example, since disturbance of display of products on the product shelf 10 is assumed, a clerk can perform work such as arrangement of the product shelf 10.

The third example embodiment and the fourth example embodiment may be combined, and in this case, the information processing device 100 includes the region identification unit 102, the correspondence identification unit 104, the product identification unit 106, the storage processing unit 108, and the output processing unit 110. Then, in the determination processing in step S305 in FIG. 19, when the first candidate and the second candidate do not match (NO in step S305), the output processing unit 110 causes the output device to output information indicating that the types of products in the shelf label region 60 and the product region 50 do not match (step S401). In a case where the first candidate and the second candidate match (YES in step S305), the product type information regarding the product of the type is read from the product information database 140, associated with the product region 50 (specifically, identification information of the product region 50), and stored in the storage device 120 (step S307 in FIG. 15).

As described above, the information processing device 100 according to the present example embodiment includes the output processing unit 110. When the first candidate and the second candidate do not match, the output processing unit 110 causes the output device to output information indicating that the types of products in the shelf label region 60 and the product region 50 do not match.

As described above, according to the information processing device 100 of the present example embodiment, it is possible to obtain an effect similar to that of the above-described example embodiment, and further, in a case where a product candidate identified from the shelf label region 60 of the shelf label 40 does not match a product candidate identified from the product region 50, the fact can be sent to the operator.

### Fifth Example Embodiment

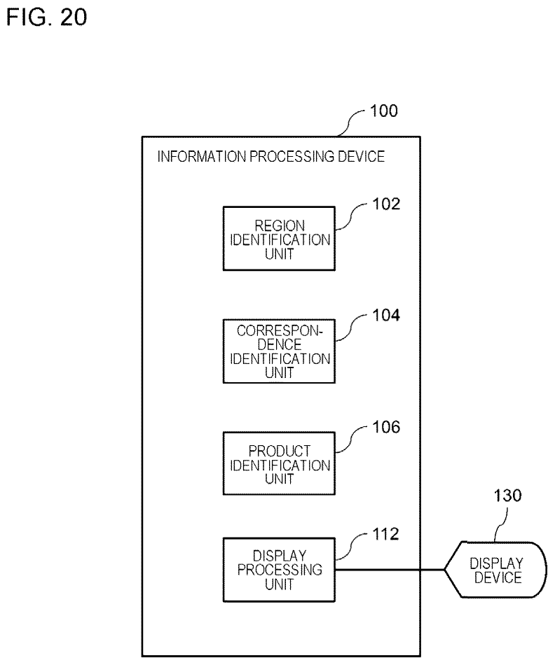

FIG. 20 is a functional block diagram illustrating a logical configuration example of an information processing device 100 according to an example embodiment. The present example embodiment is similar to any one of the above example embodiments except that the present example embodiment has a configuration in which, when a type of a product in the product region 50 is identified by image analysis, an analysis result is displayed on a screen in a recognizable manner. The configuration of the present example embodiment may be combined with at least one of the configurations of other example embodiments as long as no contradiction occurs.

### Functional Configuration Example

The information processing device 100 further includes a product identification unit 106 and a display processing unit 112 in addition to the configuration of the information processing device 100 in FIG. 1.

The product identification unit 106 identifies each product by analyzing the image.

As a result of analyzing the images of the adjacent product regions 50 by the product identification unit 106, the display processing unit 112 causes an image element identifiably indicating a region in which a matching degree between the adjacent product regions 50 is equal to or higher than a first criterion and equal to or lower than a second criterion in such a way as to be superimposed on the image.

The region where the matching degree between the adjacent product regions 50 is equal to or higher than the first criterion and equal to or lower than the second criterion is a region including two adjacent product regions 50 having similar product packages. The display processing unit 112 causes a display device 130 (for example, the display of the information processing device 100) to display a screen 200.

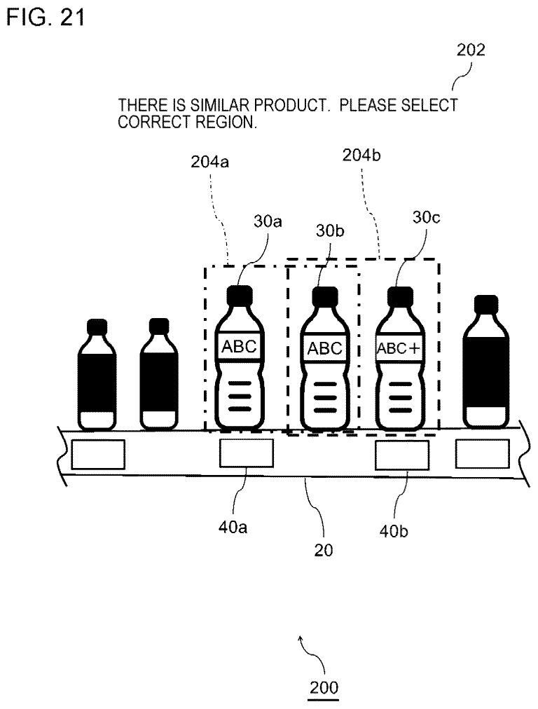

FIG. 21 is a diagram illustrating an example of the screen 200.

The screen 200 illustrates an example in which the product identification unit 106 identifies two regions in which the matching degree between the adjacent product regions 50 is equal to or higher than the first criterion and equal to or lower than the second criterion. The screen 200 includes an image of the product shelf 10 including the associated region and a message display field 202. The screen 200 may include information capable of identifying a place where the types of products in the shelf label region 60 and the product region 50 do not match, such as position information of at least one of the product shelf 10, the shelf board 20, the shelf label 40, and the product region 50.

Since there is a similar product in the message display field 202, a message prompting an operator to select a correct region is displayed. In the example of the drawing, an image of the product shelf 10 including the associated region is displayed on the screen 200, and two region drawing displays 204a and 204b are displayed in such a way as to be superimposed on the image.

As an image element identifiably indicating a region in which the matching degree between the adjacent product regions 50 is equal to or higher than the first criterion and equal to or lower than the second criterion, in this example, a shape of the image element indicating the region is rectangular. However, the shape is an example, and is not limited to a rectangle, and may be another shape. The two image elements are different line types, different colors, different thicknesses, different shaded images, and the like. Alternatively, the image element may be an image element (for example, highlight, blinking, animation image, and the like) in an enhanced expression format in such a way as to be distinguishable from other regions.

As described above, the information processing device 100 according to the present example embodiment includes the product identification unit 106 and the display processing unit 112. The product identification unit 106 identifies each product by analyzing the image. As a result of analyzing the images of the adjacent product regions 50 by the product identification unit 106, the display processing unit 112 causes an image element identifiably indicating a region in which a matching degree between the adjacent product regions 50 is equal to or higher than a first criterion and equal to or lower than a second criterion in such a way as to be superimposed on the image.

As described above, according to the information processing device 100 of the present example embodiment, it is possible to achieve effects similar to those of the above-described example embodiments, and further, in a case where the two adjacent product regions 50 are similar to each other as a result of analyzing the images of the two product regions 50, it is possible to display the two product regions 50 in a recognizable manner. The operator can recognize that there is a possibility that the discrimination result is wrong because the two product regions 50 are similar to each other, or that the discrimination result is in an indistinguishable state.

### Sixth Example Embodiment

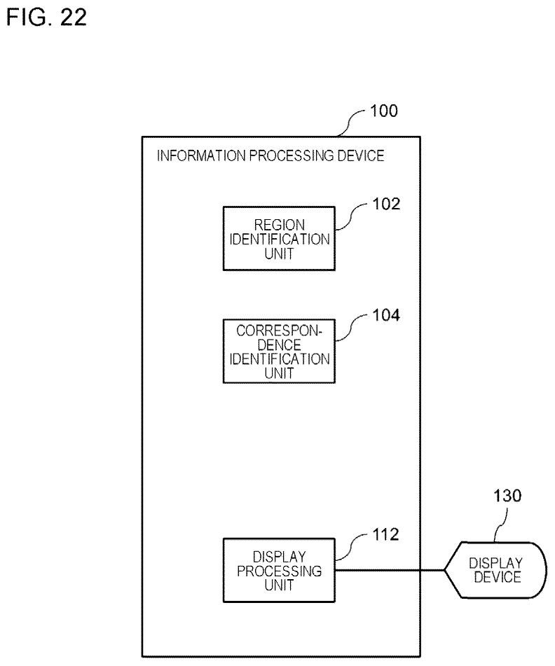

FIG. 22 is a functional block diagram illustrating a logical configuration example of an information processing device 100 according to an example embodiment. The present example embodiment is similar to any of the above example embodiments except that the correspondence identification unit 104 causes a portion where the product region 50 and the shelf label region 60 cannot be associated to be identifiably displayed on the screen.

### Functional Configuration Example

The information processing device 100 further includes a display processing unit 112 in addition to the configuration of the information processing device 100 of FIG. 1 of the first example embodiment. The configuration of the present example embodiment may be combined with at least any one of the configurations of other example embodiments other than the first example embodiment as long as no contradiction occurs.

The display processing unit 112 causes an image element identifiably indicating a portion of the product region 50 that cannot be associated with the shelf label region 60 to be displayed in such a way as to be superimposed on the image by the correspondence identification unit 104. The display processing unit 112 causes a screen 210 to be displayed on the display of the information processing device 100, for example.

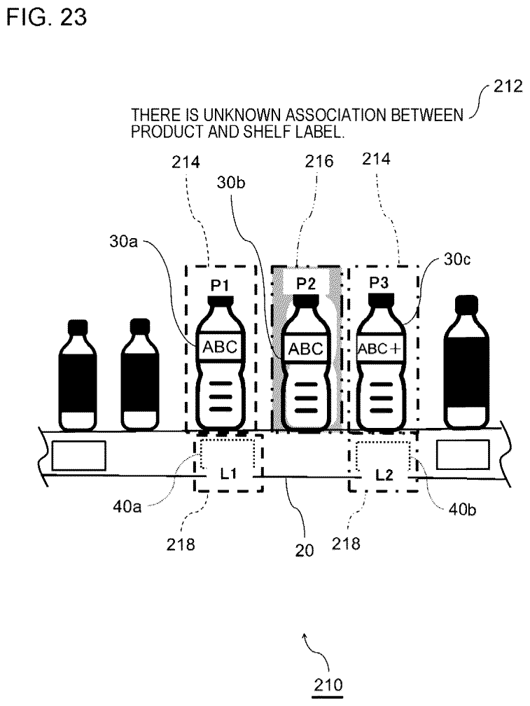

FIG. 23 is a diagram illustrating an example of the screen 210.

On the screen 210, a region of an image of the product shelf 10 including a portion of the product region 50 that cannot be associated with the shelf label region 60 is displayed by the correspondence identification unit 104. The screen 210 includes an image of the product shelf 10 including an associated region and a message display field 212. The screen 210 may include information capable of identifying a place where the types of products in the shelf label region 60 and the product region 50 do not match, such as position information of at least one of the product shelf 10, the shelf board 20, the shelf label 40, and the product region 50.

A message notifying the operator that there is an unknown association between the product region 50 (product 30) and the shelf label region 60 (shelf label 40) is displayed in the message display field 212. In the example of the drawing, an image of the product shelf 10 including the associated region is displayed on the screen 210, and a region drawing display 216 identifiably indicating a portion of the product region 50 that cannot be associated with the shelf label region 60 is displayed on the image in a superimposed manner. The screen 210 may include a product region display 214 indicating a region for which association has been completed, and a shelf label region display 218.

The region drawing display 216 may be drawn, in such a way as to be distinguishable from the product region display 214 and the shelf label region display 218, with different line types, different colors, different thicknesses, different shaded images, or the like. Alternatively, the region drawing display 216 may be drawn by an image element (for example, highlight, blinking, animation image, and the like) in an emphasized expression format in such a way as to be distinguishable from the product region display 214 and the shelf label region display 218.

The display processing unit 112 may cause the display device 130 (for example, the display of the information processing device 100) to display a screen 220 for associating the product region 50 and the shelf label region 60 whose association is unknown.

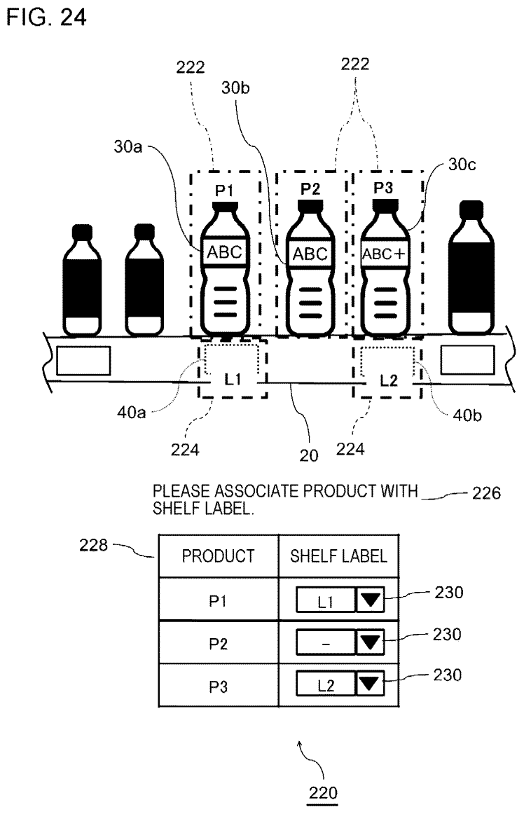

FIG. 24 is a diagram illustrating an example of the screen 220.

On the screen 220, a region of an image of the product shelf 10 including a portion of the product region 50 that cannot be associated with the shelf label region 60 is displayed by the correspondence identification unit 104. The screen 220 includes an image of the product shelf 10 including the associated region, a message display field 226, and a correspondence table 228. The screen 220 may include information capable of identifying a place where the types of products in the shelf label region 60 and the product region 50 do not match, such as position information of at least one of the product shelf 10, the shelf board 20, the shelf label 40, and the product region 50.

A message prompting the operator to associate the product 30 with the shelf label 40 is displayed in the message display field 226. In the example of the drawing, the message display field 226 includes a product region drawing display 222 associated to a product region 50 of three products P1, P2, and P3 and a shelf label region drawing display 224 associated to a shelf label region 60 of two shelf labels L1 and L2. On the screen 220, an image of the product shelf 10 including the associated region is displayed, and the product region drawing display 222 and the shelf label region drawing display 224 are displayed on the image in a superimposed manner.

In the product region drawing display 222 and the shelf label region drawing display 224, in order to distinguish between each product region 50 and each shelf label region 60, labels such as the products P1, P2, and P3 and the shelf labels L1 and L2 are attached and displayed.

This label is used when associating a product with a shelf label in the following correspondence table 228. That is, labeling is made in such a way that the products and the shelf labels associated to the products and the shelf labels in the image of the product shelf 10 are associated in the correspondence table 228. In another example, the label is not particularly limited as long as the label can be distinguished from each other, and may be product type information such as a product name recognized by image analysis, or may be a color, a symbol, a mark, or the like.

In this example, the shapes of the product region drawing display 222 and the shelf label region drawing display 224 indicating each region are rectangular. However, the shape is an example, and is not limited to a rectangle, and may be another shape. These image elements are lines of any line types, colors, and thicknesses, or shaded images. Alternatively, the image element may be an image element (for example, highlight, blinking, animation image, and the like) in an enhanced expression format in such a way as to be distinguishable from other regions.

The correspondence table 228 includes a user interface (UI) that accepts selection of the shelf label 40 to be associated with each product 30. In the example of the figure, the correspondence table 228 includes a pull-down menu 230. In the pull-down menu 230, any one of the shelf labels L1 and L2 not associated can be selected.

In the example of the drawing, the correspondence table 228 includes a UI that accepts selection of the shelf label 40 to be associated with each product 30, but in another example, may include a UI that accepts selection of a product 30 to be associated with each shelf label 40, or may include a UI that accepts selection of a combination of the shelf label 40 and the product 30.

As described above, the information processing device 100 of the present example embodiment includes the display processing unit 112. The display processing unit 112 causes an image element identifiably indicating a portion of the product region 50 that cannot be associated with the shelf label region 60 to be displayed in such a way as to be superimposed on the image by the correspondence identification unit 104. The display processing unit 112 causes the screen 220 to be displayed on the display of the information processing device 100, for example.

As described above, according to the information processing device 100 of the present example embodiment, it is possible to obtain an effect similar to that of the above-described example embodiment, and further, it is possible to identifiably display a portion of the product region 50 which is not associated with the shelf label region 60 on the screen 210. Then, by displaying the screen 220 by the display processing unit 112, it is possible to associate a portion that has not been associated.

Although the example embodiments of the present invention have been described above with reference to the drawings, these are examples of the present invention, and various configurations other than the above can be adopted.

In the plurality of flowcharts used in the above description, a plurality of steps (processing) is described in order, but the execution order of the steps executed in each example embodiment is not limited to the described order. In each example embodiment, the order of the illustrated steps can be changed as long as there is no problem in terms of content. The above-described example embodiments can be combined within a range in which the contents are not contradictory.

### Other Example Embodiments

In the above-described information processing device 100 according to the sixth example embodiment, in the configuration in which selection of association by the operator is accepted in a case where the shelf label 40 and the product region 50 cannot be associated with each other, the storage processing unit 108 may store information regarding the shelf label 40 and the product region 50 that cannot be associated with each other, and information indicating a result of association identified by selection by the operator, in association with each other. The information processing device 100 performs machine learning of association between the shelf label 40 and the product region 50 by using these pieces of information, in such a way that association by the correspondence identification unit 104 can be achieved by machine learning.

As an example, information regarding the shelf label 40 and the product region 50 that cannot be associated is set as an explanatory variable of machine learning, and information indicating a result of association identified by selection of the operator is set as an objective variable of machine learning.

### EXAMPLES

### Example 1

In Example 1, with the use of the information processing device 100 of the above example embodiments, shelf allocation of the product shelf 10 is identified, and a shelf allocation table is automatically generated.

The correspondence information 154 of the shelf label 40, the product region 50, and the product type information identified by the correspondence identification unit 104 of the information processing device 100 can be used as a shelf allocation table.

### Example 2

In Example 2, an inventory status of the products can be further managed using the shelf allocation table generated by an automatic shelf allocation table generation system of Example 1 described above. The information processing device 100 further includes a detection unit (not illustrated) that analyzes an image obtained by capturing an image of the product shelf 10 at a predetermined timing, compares the image with a shelf allocation table, and detects a stockout and a product shortage situation of the product 30. The predetermined timing may be a time zone or the like in which products are likely to be in short supply, or may be a periodic timing.

In a case where stockout or a product shortage situation is detected, the output processing unit 110 of the information processing device 100 may send this fact to a terminal or the like of a store.

### Example 3

In Example 3, the shelf allocation table generated by the automatic shelf allocation table generation system of Example 1 described above may be updated in real time. The correspondence identification unit 104 of the information processing device 100 may update the shelf allocation table as needed by analyzing an image obtained by periodically capturing an image of the product shelf 10. In a case where there is a change from the previous shelf allocation table, the output processing unit 110 of the information processing device 100 may send the fact to a terminal or the like of the store.

### Example 4

In Example 4, the shelf allocation table generated by the automatic shelf allocation table generation system of at least one of Examples 1 to 3 described above may be used for marketing for each store. The output processing unit 110 of the information processing device 100 may accumulate a change history of the shelf allocation table for each store, information regarding detection of product stockout and a product shortage situation, and the like, and cause the accumulated information to be output to a management terminal or the store terminal.

### Example 5

In Example 5, the product feature information 160 in FIG. 17 in which the product region 50, the product type information, and the image of the product region 50 stored by the storage processing unit 108 of the information processing device 100 according to the third example embodiment are associated with each other is used for machine learning of a model for product recognition.

As an example, the product image (feature information) of the product feature information 160 is used as an explanatory variable of machine learning, and the product type information is used as an objective variable of machine learning. In this case, the product feature information can be used for machine learning of a recognition model that identifies the product type information from the captured image of the product shelf 10.

While the present invention has been particularly shown and described with reference to the example embodiments and examples thereof, the present invention is not limited to these example embodiments and examples. It will be understood by those of ordinary skill in the art that various changes in form and details may be made therein without departing from the spirit and scope of the present invention as defined by the claims.

Some or all of the above example embodiments may be described as the following Supplementary Notes, but are not limited to the following.
1. An information processing device including:
a region identification means for identifying a product region for each product and identifying a shelf label region which is a region including a shelf label by analyzing an image including a product shelf; and
a correspondence identification means for identifying the product region associated to the shelf label based on a positional relationship between a position of the product region and a position of the shelf label region, in which
the correspondence identification means
identifies two of the shelf labels adjacent to each other, and identifies the product region associated to each of the shelf labels by setting a boundary indicating a separation of types of the products in the product region for each of the product regions associated to an upper region of each of the two shelf labels or between the two shelf labels.
2. The information processing device according to 1., in which
the correspondence identification means
in a case where the product region associated to each of the upper regions of the two adjacent shelf labels exists, identifies each of the product regions as the product region associated to each of the shelf labels, and
in a case where the product region associated to the upper region of at least one of the upper regions of the two adjacent shelf labels does not exist, identifies the product region associated to each of the shelf labels by setting the boundary between the two shelf labels.
3. The information processing device according to 1. or 2., in which
the correspondence identification means,
in a case where there are three or more of the product regions in an upper region of each of the adjacent shelf labels and an upper area including the two regions, analyzes the image and compares the adjacent product regions to identify the product region associated to each of the shelf labels.
4. An information processing device including:
a region identification means for identifying a product region for each product and identifying a shelf label region which is a region including a shelf label by analyzing an image including a product shelf; and
a correspondence identification means that identifies the product region associated to the shelf label based on a positional relationship between a position of the product region and a position of the shelf label region, in which
the correspondence identification means
identifies two of the shelf labels adjacent to each other, and identifies the product region associated to each of the shelf labels by setting a boundary indicating a separation of types of the products in the product region for each of the product regions associated to a lower region of each of the two shelf labels or between the two shelf labels.
5. The information processing device according to 4., in which
the correspondence identification means
in a case where the product region associated to each of the lower regions of the two adjacent shelf labels exists, identifies each of the product regions as the product region associated to each of the shelf labels, and
in a case where the product region associated to the lower region of at least one of the lower regions of the two adjacent shelf labels does not exist, identifies the product region associated to each of the shelf labels by setting the boundary between the two shelf labels.
6. The information processing device according to 4. or 5., in which
the correspondence identification means,
in a case where there are three or more of the product regions in a lower region of each of the adjacent shelf labels and a lower area including the two regions, analyzes the image and compares the adjacent product regions to identify the product region associated to each of the shelf labels.
7. The information processing device according to any one of 1. to 6., further including:
a product identification means for identifying a type of each product by analyzing the image; and
a storage processing means for storing the type of the product identified by the product identification means and the product region, which are associated to the product region associated with the shelf label by the correspondence identification means, in a storage means in association with each other.
8. The information processing device according to 7., in which
the product identification means identifies a type of the product associated to the shelf label by analyzing an image of the shelf label region included in the image.
9. The information processing device according to 7. or 8., in which
the storage processing means further stores the image in the storage means in association with the product region and the type of the product.
10. The information processing device according to any one of 7. to 9., in which
the storage processing means
further stores the shelf label region of the shelf label associated to the product region in the storage means in association with the product region and the type of the product.
11. The information processing device according to any one of 7. to 10., in which
the product identification means
identifies a first candidate for a type of a product in the product region included in the image by analyzing an image of the product region, and
identifies a second candidate for a type of a product on the shelf label in the shelf label region included in the image by analyzing an image of the shelf label region, and
the storage processing means,
in a case where the first candidate and the second candidate match, reads information regarding the product of the type from a product information storage means and stores the read information in association with the product region in the storage means.
12. The information processing device according to 11., further including
an output processing means for causing an output means to output information indicating that types of the products in the shelf label region and the product region do not match in a case where the first candidate and the second candidate do not match.
13. The information processing device according to 11. or 12., in which
in a case where a plurality of the first candidates is identified, the product identification means selects a type of a product of the first candidate that matches the second candidate as a type of a product in the product region.
14. The information processing device according to any one of 7. to 13., further including
a display processing means for causing an image element identifiably indicating a region in which a matching degree between the adjacent product regions is equal to or higher than a first criterion and equal to or lower than a second criterion to be displayed in such a way as to be superimposed on the image as a result of analyzing the images of the adjacent product regions by the product identification means.
15. The information processing device according to any one of 1. to 14., further including
a display processing means for causing an image element identifiably indicating a portion of the product region that cannot be associated with the shelf label region by the correspondence identification means to be displayed in such a way as to be superimposed on the image.
16. An information processing system including:
a camera for capturing an image of a product shelf; and
an information processing device, in which
the information processing device includes,
a region identification means for identifying a product region for each product and identifying a shelf label region which is a region including a shelf label by analyzing an image including a product shelf, and
a correspondence identification means for identifying the product region associated to the shelf label based on a positional relationship between a position of the product region and a position of the shelf label region, and
the correspondence identification means of the information processing device
identifies two of the shelf labels adjacent to each other, and identifies the product region associated to each of the shelf labels by setting a boundary indicating a separation of types of the products in the product region for each of the product regions associated to an upper region of each of the two shelf labels or between the two shelf labels.
17. The information processing system according to 16., in which
the correspondence identification means of the information processing device,
in a case where the product region associated to each of the upper regions of the two adjacent shelf labels exists, identifies each of the product regions as the product region associated to each of the shelf labels, and
in a case where the product region associated to the upper region of at least one of the upper regions of the two adjacent shelf labels does not exist, identifies the product region associated to each of the shelf labels by setting the boundary between the two shelf labels.
18. The information processing system according to 16. or 17., in which
the correspondence identification means of the information processing device,
in a case where there are three or more of the product regions in an upper region of each of the adjacent shelf labels and an upper area including the two regions, analyzes the image and compares the adjacent product regions to identify the product region associated to each of the shelf labels.
19. An information processing system including:
a camera for capturing an image of a product shelf; and
an information processing device, in which
the information processing device includes,
a region identification means for identifying a product region for each product and identifying a shelf label region which is a region including a shelf label by analyzing an image including a product shelf, and
a correspondence identification means for identifying the product region associated to the shelf label based on a positional relationship between a position of the product region and a position of the shelf label region, and
the correspondence identification means
identifies two of the shelf labels adjacent to each other, and identifies the product region associated to each of the shelf labels by setting a boundary indicating a separation of types of the products in the product region for each of the product regions associated to a lower region of each of the two shelf labels or between the two shelf labels.
20. The information processing system according to 19., in which
the correspondence identification means of the information processing device,
in a case where the product region associated to each of the lower regions of the two adjacent shelf labels exists, identifies each of the product regions as the product region associated to each of the shelf labels, and
in a case where the product region associated to the lower region of at least one of the lower regions of the two adjacent shelf labels does not exist, identifies the product region associated to each of the shelf labels by setting the boundary between the two shelf labels.
21. The information processing system according to 19. or 20., in which
the correspondence identification means of the information processing device,
in a case where there are three or more of the product regions in a lower region of each of the adjacent shelf labels and a lower area including the two regions, analyzes the image and compares the adjacent product regions to identify the product region associated to each of the shelf labels.
22. The information processing system according to any one of 16. to 21., in which
the information processing device further includes:
a product identification means for identifying a type of each product by analyzing the image; and
a storage processing means for storing the type of the product identified by the product identification means and the product region, which are associated to the product region associated with the shelf label by the correspondence identification means, in association with each other in a storage means.
23. The information processing system according to 22., in which
the product identification means of the information processing device identifies a type of the product associated to the shelf label by analyzing an image of the shelf label region included in the image.
24. The information processing system according to 22. or 23., in which
the storage processing means of the information processing device further stores the image in the storage means in association with the product region and the type of the product.
25. The information processing system according to any one of 22. to 24., in which
the storage processing means of the information processing device
further stores the shelf label region of the shelf label associated to the product region in the storage means in association with the product region and the type of the product.
26. The information processing system according to any one of 22. to 25., in which
in the information processing device,
the product identification means
identifies a first candidate for a type of a product in the product region included in the image by analyzing an image of the product region, and
identifies a second candidate for a type of a product on the shelf label in the shelf label region included in the image by analyzing an image of the shelf label region, and
the storage processing means,
in a case where the first candidate and the second candidate match, reads information regarding the product of the type from a product information storage means and stores the read information in association with the product region in the storage means.
27. The information processing system according to 26., in which
the information processing device further includes
an output processing means for causing an output means to output information indicating that types of the products in the shelf label region and the product region do not match in a case where the first candidate and the second candidate do not match.
28. The information processing system according to 26. or 27., in which
in a case where a plurality of the first candidates is identified, the product identification means of the information processing device selects a type of a product of the first candidate that matches the second candidate as a type of a product in the product region.
29. The information processing system according to any one of 22. to 28., in which
the information processing device further includes
a display processing means for causing an image element identifiably indicating a region in which a matching degree between the adjacent product regions is equal to or higher than a first criterion and equal to or lower than a second criterion to be displayed in such a way as to be superimposed on the image as a result of analyzing the images of the adjacent product regions by the product identification means.
30. The information processing system according to any one of 16. to 29., in which
the information processing device further includes
a display processing means for causing an image element identifiably indicating a portion of the product region that cannot be associated with the shelf label region by the correspondence identification means to be displayed in such a way as to be superimposed on the image.
31. An information processing method for causing one or more computers to execute processing of,
identifying a product region for each product and identifying a shelf label region which is a region including a shelf label by analyzing an image including a product shelf,
identifying the product region associated to the shelf label based on a positional relationship between a position of the product region and a position of the shelf label region, and
when identifying a correspondence,
identifying two of the shelf labels adjacent to each other, and identifying the product region associated to each of the shelf labels by setting a boundary indicating a separation of types of the products in the product region for each of the product regions associated to an upper region of each of the two shelf labels or between the two shelf labels.
32. The information processing method according to 31., in which
the one or more computers are caused to further execute processing of:
when identifying the correspondence,
in a case where the product region associated to each of the upper regions of the two adjacent shelf labels exists, identifying each of the product regions as the product region associated to each of the shelf labels; and
in a case where the product region associated to the upper region of at least one of the upper regions of the two adjacent shelf labels does not exist, identifying the product region associated to each of the shelf labels by setting the boundary between the two shelf labels.
33. The information processing method according to 31. or 32., in which
the one or more computers are caused to further execute processing of:
when identifying the correspondence,
in a case where there are three or more of the product regions in an upper region of each of the adjacent shelf labels and an upper area including the two regions, analyzing the image and comparing the adjacent product regions to identify the product region associated to each of the shelf labels.
34. An information processing method for causing one or more computers to execute processing of:
identifying a product region for each product and identifying a shelf label region which is a region including a shelf label by analyzing an image including a product shelf;
identifying the product region associated to the shelf label based on a positional relationship between a position of the product region and a position of the shelf label region; and
when identifying a correspondence,
identifying two of the shelf labels adjacent to each other, and identifying the product region associated to each of the shelf labels by setting a boundary indicating a separation of types of the products in the product region for each of the product regions associated to a lower region of each of the two shelf labels or between the two shelf labels.
35. The information processing method according to 34., in which
the one or more computers are caused to further execute processing of:
when identifying the correspondence,
in a case where the product region associated to each of the lower regions of the two adjacent shelf labels exists, identifying each of the product regions as the product region associated to each of the shelf labels; and
in a case where the product region associated to the lower region of at least one of the lower regions of the two adjacent shelf labels does not exist, identifying the product region associated to each of the shelf labels by setting the boundary between the two shelf labels.
36. The information processing method according to 34. or 35., in which
the one or more computers are caused to further execute processing of:
when identifying the correspondence,
in a case where there are three or more of the product regions in a lower region of each of the adjacent shelf labels and a lower area including the two regions, analyzing the image and comparing the adjacent product regions to identify the product region associated to each of the shelf labels.
37. The information processing method according to any one of 31. to 36., in which
the one or more computers are caused to further execute processing of:
identifying a type of each product by analyzing the image; and
storing the identified type of the product and the product region, which are associated to the product region associated with the shelf label by identifying the correspondence, in a storage means in association with each other.
38. The information processing method according to 37., in which
the one or more computers are caused to further execute processing of:
identifying a type of the product associated to the shelf label by analyzing an image of the shelf label region included in the image.
39. The information processing method according to 37. or 38., in which
the one or more computers are caused to further execute processing of:
storing the image in the storage means in association with the product region and the type of the product.
40. The information processing method according to any one of 37. to 39., in which
the one or more computers are caused to further execute processing of:
storing the shelf label region of the shelf label associated to the product region in the storage means in association with the product region and the type of the product.
41. The information processing method according to any one of 37. to 40., in which
the one or more computers are caused to further execute processing of:
identifying a first candidate for a type of a product in the product region included in the image by analyzing an image of the product region;
identifying a second candidate for a type of a product on the shelf label in the shelf label region included in the image by analyzing an image of the shelf label region; and
in a case where the first candidate and the second candidate match, reading information regarding the product of the type from a product information storage means and storing the read information in association with the product region in the storage means.
42. The information processing method according to 41., in which
the one or more computers are caused to further execute processing of:
causing an output means to output information indicating that types of the products in the shelf label region and the product region do not match in a case where the first candidate and the second candidate do not match.
43. The information processing method according to 41. or 42., in which
the one or more computers are caused to further execute processing of: in a case where a plurality of the first candidates is identified, selecting a type of a product of the first candidate that matches the second candidate as a type of a product in the product region.
44. The information processing method according to any one of 37. to 43., in which
the one or more computers are caused to further execute processing of: when identifying the product, causing an image element identifiably indicating a region in which a matching degree between the adjacent product regions is equal to or higher than a first criterion and equal to or lower than a second criterion to be displayed in such a way as to be superimposed on the image as a result of analyzing the images of the adjacent product regions.
45. The information processing method according to any one of 31. to 44., in which
the one or more computers are caused to further execute processing of: causing an image element identifiably indicating a portion of the product region that cannot be associated with the shelf label region when the correspondence is identified to be displayed in such a way as to be superimposed on the image.
46. A program for causing a computer to execute:
region identification processing for identifying a product region for each product and identifying a shelf label region which is a region including a shelf label by analyzing an image including a product shelf; and
correspondence identification processing for identifying the product region associated to the shelf label based on a positional relationship between a position of the product region and a position of the shelf label region, in which
the correspondence identification processing includes
identifying two of the shelf labels adjacent to each other, and identifying the product region associated to each of the shelf labels by setting a boundary indicating a separation of types of the products in the product region for each of the product regions associated to an upper region of each of the two shelf labels or between the two shelf labels.
47. The program according to 46., in which
the correspondence identification processing includes:
in a case where the product region associated to each of the upper regions of the two adjacent shelf labels exists, identifying each of the product regions as the product region associated to each of the shelf labels; and
in a case where the product region associated to the upper region of at least one of the upper regions of the two adjacent shelf labels does not exist, identifying the product region associated to each of the shelf labels by setting the boundary between the two shelf labels.
48. The program according to 46. or 47., in which
the correspondence identification processing includes,
in a case where there are three or more of the product regions in an upper region of each of the adjacent shelf labels and an upper area including the two regions, analyzing the image and comparing the adjacent product regions to identify the product region associated to each of the shelf labels.
49. A program for causing a computer to execute:
region identification processing for identifying a product region for each product and identifying a shelf label region which is a region including a shelf label by analyzing an image including a product shelf; and
correspondence identification processing for identifying the product region associated to the shelf label based on a positional relationship between a position of the product region and a position of the shelf label region, in which
the correspondence identification processing includes
identifying two of the shelf labels adjacent to each other, and identifying the product region associated to each of the shelf labels by setting a boundary indicating a separation of types of the products in the product region for each of the product regions associated to a lower region of each of the two shelf labels or between the two shelf labels.
50. The program according to 49., in which
the correspondence identification processing includes:
in a case where the product region associated to each of the lower regions of each of the two adjacent shelf labels exists, identifying each of the product regions as the product region associated to each of the shelf labels; and
in a case where the product region associated to the lower region of at least one of the lower regions of the two adjacent shelf labels does not exist, identifying the product region associated to each of the shelf labels by setting the boundary between the two shelf labels.
51. The program according to 49. or 50., in which
the correspondence identification processing includes,
in a case where there are three or more of the product regions in a lower region of each of the adjacent shelf labels and a lower area including the two regions, analyzing the image and comparing the adjacent product regions to identify the product region associated to each of the shelf labels.
52. The program according to any one of 46. to 51., in which
the computer is caused to further execute processing of:
product identification processing for identifying a type of each product by analyzing the image; and
processing of storage processing for storing the type of the product identified by the product identification processing and the product region, which are associated to the product region associated with the shelf label by the correspondence identification processing in association with each other in the storage processing.
53. The program according to 52., in which
the product identification processing includes identifying a type of the product associated to the shelf label by analyzing an image of the shelf label region included in the image.
54. The program according to 52. or 53., in which
the processing of storage processing includes further storing the image in association with the product region and the type of the product in the storage processing.
55. The program according to any one of 52. to 54., in which
the processing of storage processing includes
further storing the shelf label region of the shelf label associated to the product region in association with the product region and the type of the product in the storage processing.
56. The program according to any one of 52. to 55., in which
the product identification processing includes
identifying a first candidate for a type of a product in the product region included in the image by analyzing an image of the product region, and
identifying a second candidate for a type of a product on the shelf label in the shelf label region included in the image by analyzing an image of the shelf label region, and
the processing of storage processing includes,
in a case where the first candidate and the second candidate match, reading information regarding the product of the type from product information storage processing and storing the read information in association with the product region in the storage processing.
57. The program according to 56., in which
the computer is caused to further execute processing of output processing for causing information indicating that types of the products in the shelf label region and the product region do not match to be output to the output processing in a case where the first candidate and the second candidate do not match.
58. The program according to 56. or 57., in which
the product identification processing includes, in a case where a plurality of the first candidates is identified, selecting a type of a product of the first candidate that matches the second candidate as a type of a product in the product region.
59. The program according to any one of 52. to 58., in which
the computer is caused to further execute processing of display processing for causing an image element identifiably indicating a region in which a matching degree between the adjacent product regions is equal to or higher than a first criterion and equal to or lower than a second criterion to be displayed in such a way as to be superimposed on the image as a result of analyzing the images of the adjacent product regions by the product identification processing.
60. The program according to any one of 46. to 59., in which t
he computer is caused to further execute processing of display processing for causing an image element identifiably indicating a portion of the production region that cannot be associated with the shelf label region by the correspondence identification processing to be displayed in such a way as to be superimposed on the image.
61. A computer-readable recording medium recording a program for causing a computer to execute:
region identification processing for identifying a product region for each product and identifying a shelf label region which is a region including a shelf label by analyzing an image including a product shelf, and
correspondence identification processing for identifying the product region associated to the shelf label based on a positional relationship between a position of the product region and a position of the shelf label region, in which
the correspondence identification processing includes
identifying two of the shelf labels adjacent to each other, and identifying the product region associated to each of the shelf labels by setting a boundary indicating a separation of types of the products in the product region for each of the product regions associated to an upper region of each of the two shelf labels or between the two shelf labels.
62. The computer-readable recording medium recording a program according to 61., in which
the correspondence identification processing includes:
in a case where the product region associated to each of the upper regions of the two adjacent shelf labels exists, identifying each of the product regions as the product region associated to each of the shelf labels; and
in a case where the product region associated to the upper region of at least one of the upper regions of the two adjacent shelf labels does not exist, identifying the product region associated to each of the shelf labels by setting the boundary between the two shelf labels
63. The computer-readable recording medium recording a program according to 61. or 62., in which
the correspondence identification processing includes,
in a case where there are three or more of the product regions in an upper region of each of the adjacent shelf labels and an upper area including the two regions, analyzing the image and comparing the adjacent product regions to identify the product region associated to each of the shelf labels.
64. A computer-readable recording medium recording a program for causing a computer to execute:
region identification processing for identifying a product region for each product and identifying a shelf label region which is a region including a shelf label by analyzing an image including a product shelf; and
correspondence identification processing for identifying the product region associated to the shelf label based on a positional relationship between a position of the product region and a position of the shelf label region, in which
the correspondence identification processing includes
identifying two of the shelf labels adjacent to each other, and identifying the product region associated to each of the shelf labels by setting a boundary indicating a separation of types of the products in the product region for each of the product regions associated to a lower region of each of the two shelf labels or between the two shelf labels.
65. The computer-readable recording medium recording a program according to 64., in which
the correspondence identification processing includes:
in a case where the product region associated to each of the lower regions of the two adjacent shelf labels exists, identifying each of the product regions as the product region associated to each of the shelf labels; and
in a case where the product region associated to the lower region of at least one of the lower regions of the two adjacent shelf labels does not exist, identifying the product region associated to each of the shelf labels by setting the boundary between the two shelf labels.
66. The computer-readable recording medium recording a program according to 64. or 65., in which
the correspondence identification processing includes,
in a case where there are three or more of the product regions in a lower region of each of the adjacent shelf labels and a lower area including the two regions, analyzing the image and comparing the adjacent product regions to identify the product region associated to each of the shelf labels.
67. The computer-readable recording medium recording a program according to any one of 61. to 66., in which
the computer is caused to further execute:
product identification processing for identifying a type of each product by analyzing the image; and
processing of storage processing for storing the type of the product identified by the product identification processing and the product region, which are associated to the product region associated with the shelf label by the correspondence identification processing in association with each other in the storage processing.
68. The computer-readable recording medium recording a program according to 67., in which
the product identification processing includes identifying a type of the product associated to the shelf label by analyzing an image of the shelf label region included in the image.
69. The computer-readable recording medium recording a program according to 67. or 68., in which
the processing of storage processing includes further storing the image in the storage processing in association with the product region and the type of the product.
70. The computer-readable recording medium recording a program according to any one of 67. to 69., in which
the processing of storage processing includes
further storing the shelf label region of the shelf label associated to the product region in the storage processing in association with the product region and the type of the product.
71. The computer-readable recording medium recording a program according to any one of 67. to 70., in which
the product identification processing includes:
identifying a first candidate for a type of a product in the product region included in the image by analyzing an image of the product region; and
identifying a second candidate for a type of a product on the shelf label in the shelf label region included in the image by analyzing an image of the shelf label region, and
the processing of storage processing includes,
in a case where the first candidate and the second candidate match, reading information regarding the product of the type from product information storage processing and storing the read information in association with the product region in the storage processing.
72. The computer-readable recording medium recording a program according to 71., in which
the program further causes the computer to further execute processing of output processing for causing information indicating that types of the products in the shelf label region and the product region do not match to be output in a case where the first candidate and the second candidate do not match.
73. The computer-readable recording medium recording a program according to 71. or 72., in which
the product identification processing includes, in a case where a plurality of the first candidates is identified, selecting the type of the product of the first candidate that matches the second candidate as a type of a product in the product region.
74. The computer-readable recording medium recording a program according to 67. to 73., in which
the computer is caused to further execute processing of display processing for causing an image element identifiably indicating a region in which a matching degree between the adjacent product regions is equal to or higher than a first criterion and equal to or lower than second criterion to be displayed in such a way as to be superimposed on the image as a result of analyzing the images of the adjacent product regions by the product identification processing. 75. The computer-readable recording medium recording a program according to any one of 61. to 74., in which
the computer is caused to further execute processing of display processing for causing an image element identifiably indicating a portion of the product region that cannot be associated with the shelf label region by the correspondence identification processing to be displayed in such a way as to be superimposed on the image.

### REFERENCE SIGNS LIST

1 information processing system
3 communication network
5 camera
10 product shelf
20 shelf board
30, 30a, 30b product
40,40a, 40b shelf label
50, 50a, 50b, 50c product region
52 area
56 region
60,60a, 60b shelf label region
100 information processing device
104 correspondence identification unit
106 product identification unit
108 storage processing unit
110 output processing unit
112 display processing unit
120 storage device
140 product information database
150 shelf label region information
152 product region information
154 correspondence information
160 product feature information
200, 210, 220 screen
1000 computer
1010 bus
1020 processor
1030 memory
1040 storage device
1050 input/output interface
1060 network interface

What is claimed is:

1. An information processing apparatus comprising:
at least one memory storing instructions; and
at least one processor configured to execute the instructions to:
identify a product region for each product and identify a shelf label region which is a region including a shelf label by analyzing an image including a product shelf; and
identify the product region associated to the shelf label based on a positional relationship between a position of the product region and a position of the shelf label region, wherein
the at least one processor is configured to execute the instructions to
identify two of the shelf labels adjacent to each other, and identify the product region associated to each of the shelf labels by setting a boundary indicating a separation of types of the products in the product region for each of the product regions associated to an upper region of each of the two shelf labels or between the two shelf labels.

2. The information processing apparatus according to claim 1, wherein
the at least one processor is configured to execute the instructions to
in a case where the product region associated to each of the upper regions of the two adjacent shelf labels exists, identify each of the product regions as the product region associated to each of the shelf labels, and
in a case where the product region associated to the upper region of at least one of the upper regions of the two adjacent shelf labels does not exist, identify the product region associated to each of the shelf labels by setting the boundary between the two shelf labels.

3. The information processing apparatus according to claim 1, wherein
the at least one processor is configured to execute the instructions to
in a case where there are three or more of the product regions in an upper region of each of the adjacent shelf labels and an upper area including the two regions, analyze the image and compares the adjacent product regions to identify the product region associated to each of the shelf labels.

4. The information processing apparatus according to claim 1, wherein the at least one processor is further configured to execute the instructions to:
identify a type of each product by analyzing the image; and
store the type of the product identified by the product identification means and the product region, which are associated to the product region associated with the shelf label by the correspondence identification means, in a storage means in association with each other.

5. The information processing apparatus according to claim 4, wherein the at least one processor is configured to execute the instructions to
identify a type of the product associated to the shelf label by analyzing an image of the shelf label region included in the image.

6. The information processing apparatus according to claim 4, wherein the at least one processor is configured to execute the instructions to
further store the image in the storage means in association with the product region and the type of the product.

7. The information processing apparatus according to claim 4, wherein the at least one processor is configured to execute the instructions to
further store the shelf label region of the shelf label associated to the product region in the storage means in association with the product region and the type of the product.

8. The information processing apparatus according to claim 4, wherein the at least one processor is configured to execute the instructions to:
identify a first candidate for a type of a product in the product region included in the image by analyzing an image of the product region;
identify a second candidate for a type of a product on the shelf label in the shelf label region included in the image by analyzing an image of the shelf label region; and
in a case where the first candidate and the second candidate match, read information regarding the product of the type from a product information storage means and store the read information in association with the product region in the storage means.

9. The information processing apparatus according to claim 8, wherein the at least one processor is further configured to execute the instructions to
cause an output means to output information indicating that types of the products in the shelf label region and the product region do not match in a case where the first candidate and the second candidate do not match.

10. The information processing apparatus according to claim 8, wherein the at least one processor is configured to execute the instructions to,
in a case where a plurality of the first candidates is identified, select a type of a product of the first candidate that matches the second candidate as a type of a product in the product region.

11. The information processing apparatus according to claim 4, wherein the at least one processor is further configured to execute the instructions to
cause an image element identifiably indicating a region in which a matching degree between the adjacent product regions is equal to or higher than a first criterion and equal to or lower than a second criterion to be displayed in such a way as to be superimposed on the image as a result of analyzing the images of the adjacent product regions by the product identification means.

12. The information processing apparatus according to claim 1, wherein the at least one processor is further configured to execute the instructions to
cause an image element identifiably indicating a portion of the product region that cannot be associated with the shelf label region by the correspondence identification means to be displayed in such a way as to be superimposed on the image.

13-24. (canceled)

25. An information processing method for causing one or more computers to execute processing of:
identifying a product region for each product and identifying a shelf label region which is a region including a shelf label by analyzing an image including a product shelf;
identifying the product region associated to the shelf label based on a positional relationship between a position of the product region and a position of the shelf label region; and
when identifying a correspondence,
identifying two of the shelf labels adjacent to each other, and identifying the product region associated to each of the shelf labels by setting a boundary indicating a separation of types of the products in the product region for each of the product regions associated to an upper region of each of the two shelf labels or between the two shelf labels.

26-36. (canceled)

37. A non-transitory computer-readable medium recording a program for causing a computer to execute:
region identification processing for identifying a product region for each product and identifying a shelf label region which is a region including a shelf label by analyzing an image including a product shelf; and
correspondence identification processing for identifying the product region associated to the shelf label based on a positional relationship between a position of the product region and a position of the shelf label region, wherein
the correspondence identification processing includes
identifying two of the shelf labels adjacent to each other, and identifying the product region associated to each of the shelf labels by setting a boundary indicating a separation of types of the products in the product region for each of the product regions associated to an upper region of each of the two shelf labels or between the two shelf labels.

38-48. (canceled)
